(19) United States
(12) Patent Application Publication
(10) Pub. No.: US 2015/0051075 A1
(43) Pub. Date: Feb. 19, 2015

(54) USE OF AN AGROCHEMICAL COMPOSITION WITH HERBICIDAL ACTION IN SOYBEANS

(71) Applicants: BASF SE, Ludwigshafen (DE); Federal Technological University of Parana, Curitiba (BR); Federal University Foundation of Mato Grosso, Cuiaba (BR); Federal University of Rio Grande Do Sul, Porto Alegre (BR); Federal University of Santa Maria, Santa Maria (BR)

(72) Inventors: Markus Gewehr, Kastellaun (DE); Cyrill Zagar, Raleigh, NC (US); Scott Peoples, Raleigh, NC (US); Aldo Merotto, JR., Porto Alegre (BR); Ribas Vidal, Porto Alegre (BR); Sebastiao Carneiro Guimaraes, Cuiaba (BR); Michelangelo Muzell Trezzi, Pato Branco (BR); Fabiane Pinto Lamego, Frederico Westphalen (BR)

(21) Appl. No.: 14/381,088

(22) PCT Filed: Feb. 27, 2013
(86) PCT No.: PCT/EP2013/053942

§ 371 Date: Aug. 26, 2014

Related U.S. Application Data
(60) Provisional application No. 61/605,212, filed on Mar. 1, 2012.

(51) Int. Cl. A01N 57/20; A01N 43/18; A01N 43/76; A01N 37/40; A01N 43/60; A01N 43/16; A01N 47/36; A01N 41/12; A01N 43/40

(52) U.S. Cl. CPC A01N 57/20; A01N 41/12; A01N 43/18; A01N 43/76; A01N 43/40; A01N 43/60; A01N 43/16; A01N 47/36; A01N 37/40
USPC 504/165; 504/344; 504/288; 504/270; 504/258; 504/235; 504/292; 504/214; 504/324; 504/206; 504/168; 504/167; 504/171; 504/173

(57) ABSTRACT

The present invention relates to the use of an agrochemical composition comprising at least one specific herbicide and at least one specific fungicide for controlling undesired vegetation in soybean cultures and for the desiccation and/or defoliation of soybeans.

The invention further relates to a method for controlling undesired vegetation in soybean cultures and to a method for the desiccation and/or defoliation of soybean plants.

The present invention relates to the use of an agrochemical composition comprising at least one specific herbicide and at least one specific fungicide for controlling undesired vegetation in soybean cultures and for the desiccation and/or defoliation of soybeans. The invention further relates to a method for controlling undesired vegetation in soybean cultures and to a method for the desiccation and/or defoliation of soybean plants.

In the case of crop protection, such as herbicidal compositions, it is desirable in principle to increase the specific activity of an active compound and the reliability of the effect. For an herbicidal composition, it is particularly desirable to control harmful plants effectively, but at the same time to be compatible with the useful plants in question. Also desirable is a broad spectrum of activity allowing the simultaneous control of harmful plants. Frequently, this cannot be achieved using a single active compound.

With many highly effective herbicides, there is the problem that their compatibility with useful plants, in particular dicotyledonous crop plants, such as cotton, oilseed rape and graminaceous plants, such as barley, millet, corn, rice, wheat and sugar cane, is not always satisfactory, i.e. in addition to the harmful plants, the crop plants, too, are damaged on a scale which cannot be tolerated. By reducing the application rates, the useful plants are spared; however, naturally, the extent of the control of harmful plants decreases, too.

It is known that special combinations of different specifically active herbicides result in enhanced activity of a herbicide component in the sense of a synergistic effect. In this manner, it is possible to reduce the application rates of herbicidal active compounds required for controlling the harmful plants.

Furthermore, it is known that in some cases joint application of specifically acting herbicides with other organic active compounds allows better crop plant compatibility to be achieved. In these cases, the active compounds act as antidotes or antagonists and are also referred to as safeners, since they reduce or even prevent damage to the crop plants.

Soybeans are among the most important crop plants. Improving their growth conditions is thus an ongoing need.

It is an object of the present invention to provide agrochemical compositions which are highly active against unwanted harmful plants in soybean cultures.

This and further objects are achieved by the agricultural composition described below. Surprisingly, this composition has better herbicidal activity, i.e. a better activity against harmful plants, than would have been expected based on the herbicidal activity observed for the individual compounds, or a broader activity spectrum.

Moreover, the time frame, within which the desired herbicidal action can be achieved, may be expanded by said composition. This allows a more flexibly timed application of the compositions according to the present invention in comparison with the single compounds.

Said composition also has a better compatibility with useful plants.

Accordingly, the present invention relates to the use of an agrochemical composition comprising
A) at least one herbicide A selected from
   A.a) acetylCoA carboxylase inhibitors (ACC inhibitors) selected from clethodim (A.1), cycloxydim (A.2), fenoxaprop (A.3), fluazifop (A.4), fluazifop-P (A.5), haloxyfop (A.6), haloxyfop-P (A.7), quizalofop (A.8), quizalofop-P (A.9), sethoxydim (A.10) and tepraloxydim (A.11);
   A.b) acetolactate synthase inhibitors (ALS inhibitors) selected from chlorimuron (A.12), cloransulam (A.13), diclosulam (A.14), flumetsulam (A.15), thifensulfuron (A.16) and tribenuron (A.17);
   A.c) auxinic herbicides selected from 2,4-D (A.18) and dicamba (A.19);
   A.d) the glutamine synthase (GS) inhibitor glufosinate (A.20);
   A.e) the photosynthetic electron transport inhibitor at the photosystem II receptor site bentazone (A.21); and
   A.f) 4-hydroxyphenylpyruvate-dioxygenase (HPPD inhibitors) selected from bicyclopyrone (A.22), isoxaflutole (A.23), mesotrione (A.24), sulcotrione (A.25), tembotrione (A.26) and topramezone (A.27);
      and their agriculturally acceptable salts esters and amides; and
B) at least one fungicide B selected from
   B.a) inhibitors of complex III at Qₒ site selected from azoxystrobin (B.1), coumethoxystrobin (B.2), coumoxystrobin (B.3), dimoxystrobin (B.4), enestroburin (B.5), fenaminstrobin (B.6), fenoxystrobin/flufenoxystrobin (B.7), fluoxastrobin (B.8), kresoxim-methyl (B.9), metominostrobin (B.10), orysastrobin (B.11), picoxystrobin (B.12), pyraclostrobin (B.13), pyrametostrobin (B.14), pyraoxystrobin (B.15), trifloxystrobin (B.16), 2-[2-(2,5-dimethylphenyl-oxymethyl)phenyl]-3-methoxy-acrylic acid methyl ester (B.17), 2-(2-(3-(2,6-dichlorphenyl)-1-methyl-allylideneaminooxymethyl)-phenyl)-2-methoxyimino-N-methyl-acetamide (B.18), pyribencarb (B.19), and triclopyricarb/chlorodincarb (B.20);
   B.b) inhibitors of complex II selected from bixafen (B.21), boscalid (B.22), carboxin (B.23), fluxapyroxad (B.24), isopyrazam (B.25), penflufen (B.26), penthiopyrad (B.27), sedaxane (B.28), 3-difluoromethyl-1-methyl-1H-pyrazole-4-carboxylic acid (9-dichloromethylene-1,2,3,4-tetrahydro-1,4-methano-naphthalen-5-yl)-amide (B.29), and 3-difluoromethyl-1-methyl-1H-pyrazole-4-carboxylic acid (2-(2,4-dichloro-phenyl)-2-methoxy-1-methyl-ethyl)-amide (B.30); and
   B.c) the respiration inhibitor fluazinam (B.31); for controlling undesired vegetation in soybean cultures.

In the context of the present invention, the term “soybean” denotes both the plant itself as well as its harvested product, such as soybean grains or seeds.

The invention moreover relates to a composition as defined above or below, comprising at least one herbicide A and at least one fungicide B.

The composition to be used according to the invention may be a physical mixture of the at least one compound A and the at least one compound B. Accordingly, the invention also provides a mixture comprising at least one compound A and at least one compound B. However, the composition may also be any combination of at least one compound A with at least one compound B, it not being required for compounds A and B to be present together in the same formulation.

An example of a composition according to the invention or to be used according to the invention in which the at least one compound A and the at least one compound B are not present together in the same formulation is a combipack. In a combipack, two or more components of a combipack are packaged separately, i.e., not jointly preformulated. As such, combipacks include one or more separate containers such as vials, cans, bottles, pouches, bags or canisters, each container containing a separate component for an agrochemical composition. One example is a two-component combipack. Accordingly the present invention also relates to a two-component combipack, comprising a first component which in turn comprises at least one compound A, a liquid or solid carrier and, if appropriate, at least one surfactant and/or at least one customary auxiliary, and a second component which in turn comprises at least one compound B, a liquid or solid carrier and, if appropriate, at least one surfactant and/or at least one customary auxiliary. More details, e.g. as to suitable liquid and solid carriers, surfactants and customary auxiliaries are described below.

The invention furthermore relates to a method for controlling undesired vegetation in soybean cultures, which method comprises allowing an effective amount of an agrochemical composition as defined above or below to act on the soybean plants or parts thereof and/or on the environment where the soybean cultures grow or are to grow. The soybeans might be resistant to one or more herbicides or to attack by insects owing to genetic engineering or breeding.

The invention relates moreover to the use of a composition as defined above or below, for the desiccation and/or defoliation of soybean plants, and to a method for the desiccation and/or defoliation of soybean plants, which method comprises treating soybean plants or parts thereof with an effective amount of an agrochemical composition as defined above or below.

The methods of the invention comprise allowing an effective amount of the composition as defined above or below to act on soybean plants or parts thereof and/or the environment (e.g. the locus) where the soybean cultures grow or are to grow. The methods of the invention include treatment of the seeds from which the soybean plants are to grow. If the soybean plants are not resistant against the herbicide(s) used and/or the herbicide(s) is/are not selective enough and/or no safener is used, it is convenient to avoid their direct contact with the herbicide(s) used as far as possible in order to avoid injury of the soybean plants (except, of course, for the desiccation and/or defoliation method). This can be done, for example, by treating as selectively as possible the undesired vegetation or the locus where this is growing or expected to grow (this applies of course only for the herbicidal method) or by treating the locus where the soybean plant is to grow, e.g. before or during sowing or before its emergence or before planting, or by treating the seeds of the soybean plant with the composition of the invention or, if the composition is not a physical mixture of herbicide and fungicide, with the herbicide of the composition. In all other cases, i.e. if the soybean plants are resistant against the herbicide(s) used and/or the herbicide is sufficiently selective and does not harm (or not to an economically dissatisfactory extent) the soybean plants and/or a safener is used, any known method for broadcasting agricultural compositions can be used. For further details, see below.

The herbicides A and the fungicides B as well as their agrochemical action and methods for producing them are generally known. For instance, the commercially available compounds can be found in “The Pesticide Manual, 15th Edition, British Crop Protection Council (2009)” among other publications.

The preferred embodiments of the invention mentioned herein below have to be understood as being preferred either independently from each other or in combination with one another.

Preferably, the at least one herbicide A is selected from clethodim, cycloxydim, sethoxydim, tepraloxydim, chlorimuron, cloransulam, thifensulfuron, tribenuron, 2,4-D, dicamba, bentazone, bicyclopyrone, isoxaflutole, mesotrione, tembotrione, topramezone; and their agriculturally acceptable salts, esters and amides.

Among the agriculturally acceptable salts, esters and amides of the above herbicides, preference is given to the following compounds:
chlorimuron: chlorimuron-ethyl (A.28);
cloransulam: cloransulam-methyl (A.29);
thifensulfuron: thifensulfuron-methyl (A.30);
tribenuron: tribenuron-methyl (A.31);
2,4-D: 2,4-D-ammonium (A.32), 2,4-D-butotyl (A.33), 2,4-D-2-butoxypropyl (A.34), 2,4-D-3-butoxypropyl (A.35) 2,4-D-butyl (A.36), 2,4-D-diethylammonium (A.36), 2,4-D-dimethylammonium (A.37), 2,4-D-diolamine (A.38), 2,4-D-dodecylammonium (A.40), 2,4-D-ethyl (A.41), 2,4-D-2-ethylhexyl (A.42), 2,4-D-heptylammonium (A.43), 2,4-D-isobutyl (A.44), 2,4-D-isooctyl (A.45), 2,4-D-isopropyl (A.46), 2,4-D-isopropylammonium (A.47), 2,4-D-lithium (A.48), 2,4-D-meptyl (A.49), 2,4-D-methyl (A.50), 2,4-D-octyl (A.51), 2,4-D-pentyl (A.52), 2,4-D-propyl (A.53), 2,4-D-sodium (A.54), 2,4-D-tefuryl (A.55), 2,4-D-tetradecylammonium (A.56), 2,4-D-triethylammonium (A.57), 2,4-D-tris(2-hydroxypropyl)ammonium (A.58), 2,4-D-tris(isopropyl)ammonium (A.59), 2,4-D-trolamine (A.60), 2,4-D-(2-hydroxyethyl)trimethylammonium (A.61);
dicamba: dicamba-butotyl (A.62), dicamba-diglycolamine (A.63), dicamba-dimethylammonium (A.64), dicamba-diolamine (A.65), dicamba-isopropylammonium (A.66), dicamba-methyl (A.67), dicamba-olamine (A.68), dicamba-potassium (A.69), dicamba-sodium (A.70), dicamba-trolamine (A.71), dicamba-N,N-bis-(3-aminopropyl)methylamine (A.72), dicamba-diethylenetriamine (A.73);
bentazone: bentazone-sodium (A.74).

Among the agriculturally acceptable salts, esters and amides of 2,4-D and dicamba, more preference is given to following salts and esters:
2,4-D: 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isooctyl, 2,4-D-isopropyl, 2,4-D-isopropylammonium, 2,4-D-sodium, 2,4-D-tris(isopropyl)ammonium, 2,4-D-trolamine, 2,4-D-(2-hydroxyethyl)trimethylammonium;
dicamba: dicamba-butotyl, dicamba-diglycolamine, dicamba-dimethylammonium, dicamba-diolamine, dicamba-isopropylammonium, dicamba-potassium, dicamba-sodium, dicamba-trolamine, dicamba-N,N-bis-(3-aminopropyl)-methylamine, dicamba-diethylenetriamine.

The at least one herbicide A is more preferably selected from clethodim, cycloxydim, sethoxydim, tepraloxydim, chlorimuron, chlorimuron-ethyl, cloransulam, cloransulam-methyl, thifensulfuron, thifensulfuron-methyl, tribenuron, tribenuron-methyl, 2,4-D, 2,4-D-ammonium, 2,4-D-butotyl, 2,4-D-2-butoxypropyl, 2,4-D-3-butoxypropyl, 2,4-D-butyl, 2,4-D-diethylammonium, 2,4-D-dimethylammonium, 2,4-D-diolamine, 2,4-D-dodecylammonium, 2,4-D-ethyl, 2,4-D-2-ethylhexyl, 2,4-D-heptylammonium, 2,4-D-isobutyl, 2,4-D-isooctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-(2-hydroxyethyl)trimethylammonium, dicamba, dicamba-butotyl, dicamba-diglycolamine, dicamba-dimethylammonium, dicamba-diolamine, dicamba-isopropylammonium, dicamba-methyl, dicamba-olamine, dicamba-potassium, dicamba-sodium, dicamba-trolamine, dicamba-N,N-bis-(3-aminopropyl)methylamine, dicamba-diethylenetriamine, bentazone, bentazone-sodium, bicyclopyrone, isoxaflutole, mesotrione, tembotrione and topramezone.

Even more preferably, the at least one herbicide A is selected from clethodim, cycloxydim, sethoxydim, tepraloxydim, 2,4-D, dicamba, bentazone, mesotrione, topramezone; and their agriculturally acceptable salts, esters and amides.

Particularly preferably, the at least one herbicide A is selected from clethodim, cycloxydim, sethoxydim, tepraloxydim, 2,4-D, 2,4-D-ammonium, 2,4-D-butotyl, 2,4-D-2-butoxypropyl, 2,4-D-3-butoxypropyl, 2,4-D-butyl, 2,4-D-diethylammonium, 2,4-D-dimethylammonium, 2,4-D-diolamine, 2,4-D-dodecylammonium, 2,4-D-ethyl, 2,4-D-2-ethylhexyl, 2,4-D-heptylammonium, 2,4-D-isobutyl, 2,4-D-isooctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-(2-hydroxyethyl)trimethylammonium, dicamba, dicamba-butotyl, dicamba-diglycolamine, dicamba-dimethylammonium, dicamba-diolamine, dicamba-isopropylammonium, dicamba-methyl, dicamba-olamine, dicamba-potassium, dicamba-sodium, dicamba-trolamine, dicamba-N,N-bis-(3-aminopropyl)methylamine, dicamba-diethylenetriamine, bentazone, bentazone-sodium, mesotrione and topramezone.

In particular, the at least one herbicide A is selected from clethodim, cycloxydim, sethoxydim, tepraloxydim, 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isooctyl, 2,4-D-isopropyl, 2,4-D-isopropylammonium, 2,4-D-sodium, 2,4-D-tris(isopropyl)ammonium, 2,4-D-trolamine, 2,4-D-(2-hydroxyethyl)trimethylammonium, dicamba, dicamba-butotyl, dicamba-diglycolamine, dicamba-dimethylammonium, dicamba-diolamine, dicamba-isopropylammonium, dicamba-potassium, dicamba-sodium, dicamba-trolamine, dicamba-N,N-bis-(3-aminopropyl)-methylamine, dicamba-diethylenetriamine, bentazone, bentazone-sodium, mesotrione and topramezone.

In a particular embodiment, the at least one herbicide A is clethodim and the at least one fungicide B has one of the above general or, in particular, one of the below preferred meanings.

In another particular embodiment, the at least one herbicide A is cycloxydim and the at least one fungicide B has one of the above general or, in particular, one of the below preferred meanings.

In another particular embodiment, the at least one herbicide A is sethoxydim and the at least one fungicide B has one of the above general or, in particular, one of the below preferred meanings.

In another particular embodiment, the at least one herbicide A is tepraloxydim and the at least one fungicide B has one of the above general or, in particular, one of the below preferred meanings.

In another particular embodiment, the at least one herbicide A is 2,4-D and the at least one fungicide B has one of the above general or, in particular, one of the below preferred meanings.

In another particular embodiment, the at least one herbicide A is dicamba and the at least one fungicide B has one of the above general or, in particular, one of the below preferred meanings.

In another particular embodiment, the at least one herbicide A is bentazone and the at least one fungicide B has one of the above general or, in particular, one of the below preferred meanings.

In another particular embodiment, the at least one herbicide A is mesotrione and the at least one fungicide B has one of the above general or, in particular, one of the below preferred meanings.

In another particular embodiment, the at least one herbicide A is topramezone and the at least one fungicide B has one of the above general or, in particular, one of the below preferred meanings.

Preferably, the at least one fungicide is selected from azoxystrobin, dimoxystrobin, kresoxim-methyl, picoxystrobin, pyraclostrobin, trifloxystrobin, bixafen, boscalid, fluxapyroxad, isopyrazam, penflufen, penthiopyrad, sedaxane, 3-difluoromethyl-1-methyl-1H-pyrazole-4-carboxylic acid (9-dichloromethylene-1,2,3,4-tetrahydro-1,4-methano-naphthalen-5-yl)-amide and 3-difluoromethyl-1-methyl-1H-pyrazole-4-carboxylic acid (2-(2,4-dichloro-phenyl)-2-methoxy-1-methyl-ethyl)-amide.

More preferably, the at least one fungicide is selected from azoxystrobin, dimoxystrobin, kresoxim-methyl, pyraclostrobin, trifloxystrobin, bixafen, boscalid, fluxapyroxad, isopyrazam, penflufen, penthiopyrad, 3-difluoromethyl-1-methyl-1H-pyrazole-4-carboxylic acid (9-dichloromethylene-1,2,3,4-tetrahydro-1,4-methano-naphthalen-5-yl)-amide and 3-difluoromethyl-1-methyl-1H-pyrazole-4-carboxylic acid (2-(2,4-dichloro-phenyl)-2-methoxy-1-methyl-ethyl)-amide.

In a particular embodiment, the at least one fungicide B is azoxystrobin and the at least one herbicide A has one of the above general or, in particular, one of the preferred meanings.

In another particular embodiment, the at least one fungicide B is dimoxystrobin and the at least one herbicide A has one of the above general or, in particular, one of the preferred meanings.

In another particular embodiment, the at least one fungicide B is kresoxim-methyl and the at least one herbicide A has one of the above general or, in particular, one of the preferred meanings.

In another particular embodiment, the at least one fungicide B is pyraclostrobin and the at least one herbicide A has one of the above general or, in particular, one of the preferred meanings.

In another particular embodiment, the at least one fungicide B is trifloxystrobin and the at least one herbicide A has one of the above general or, in particular, one of the preferred meanings.

In another particular embodiment, the at least one fungicide B is bixafen and the at least one herbicide A has one of the above general or, in particular, one of the preferred meanings.

In another particular embodiment, the at least one fungicide B is boscalid and the at least one herbicide A has one of the above general or, in particular, one of the preferred meanings.

In another particular embodiment, the at least one fungicide B is fluxapyroxad and the at least one herbicide A has one of the above general or, in particular, one of the preferred meanings.

In another particular embodiment, the at least one fungicide B is isopyrazam and the at least one herbicide A has one of the above general or, in particular, one of the preferred meanings.

In another particular embodiment, the at least one fungicide B is penflufen and the at least one herbicide A has one of the above general or, in particular, one of the preferred meanings.

In another particular embodiment, the at least one fungicide B is penthiopyrad and the at least one herbicide A has one of the above general or, in particular, one of the preferred meanings.

In another particular embodiment, the at least one fungicide B is 3-difluoromethyl-1-methyl-1H-pyrazole-4-carboxylic acid (9-dichloromethylene-1,2,3,4-tetrahydro-1,4-methano-naphthalen-5-yl)-amide and the at least one herbicide A has one of the above general or, in particular, one of the preferred meanings.

In another particular embodiment, the at least one fungicide B is 3-difluoromethyl-1-methyl-1H-pyrazole-4-carboxylic acid (2-(2,4-dichloro-phenyl)-2-methoxy-1-methyl-ethyl)-amide and the at least one herbicide A has one of the above general or, in particular, one of the preferred meanings.

In particular, the composition to be used in the uses and the methods according to the invention comprises
A) at least one herbicide A selected from clethodim, cycloxydim, sethoxydim, tepraloxydim, 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isooctyl, 2,4-D-isopropyl, 2,4-D-isopropylammonium, 2,4-D-sodium, 2,4-D-tris(isopropyl)ammonium, 2,4-D-trolamine, 2,4-D-(2-hydroxyethyl)trimethylammonium, dicamba, dicamba-butotyl, dicamba-diglycolamine, dicamba-dimethylammonium, dicamba-diolamine, dicamba-isopropylammonium, dicamba-potassium, dicamba-sodium, dicamba-trolamine, dicamba-N,N-bis-(3-aminopropyl)-methylamine, dicamba-diethylenetriamine, bentazone, bentazone-sodium, mesotrione, topramezone; and other agriculturally acceptable salts, esters and amides; and
B) at least one fungicide B selected from azoxystrobin, dimoxystrobin, kresoxim-methyl, pyraclostrobin, trifloxystrobin, bixafen, boscalid, fluxapyroxad, isopyrazam, penflufen, penthiopyrad, 3-difluoromethyl-1-methyl-1H-pyrazole-4-carboxylic acid (9-dichloromethylene-1,2,3,4-tetrahydro-1,4-methano-naphthalen-5-yl)-amide and 3-difluoromethyl-1-methyl-1H-pyrazole-4-carboxylic acid (2-(2,4-dichloro-phenyl)-2-methoxy-1-methyl-ethyl)-amide.

According to a preferred embodiment of the invention, the composition comprises as component A at least one, preferably exactly one, herbicide A. According to another preferred embodiment of the invention, the composition comprises as component A at least two, preferably exactly two, herbicides A different from each other.

According to another preferred embodiment of the invention, the composition comprises as component A at least three, preferably exactly three, herbicides A different from each other.

According to another preferred embodiment of the invention, the composition comprises as component B at least one, preferably exactly one, fungicide B.

According to another preferred embodiment of the invention, the composition comprises as component B at least two, preferably exactly two, fungicides B different from each other.

According to another preferred embodiment of the invention, the composition comprises as component A at least one, preferably exactly one, herbicide A, and at least one, preferably exactly one, fungicide B.

According to another preferred embodiment of the invention, the composition comprises as component A at least two, preferably exactly two, herbicides A different from each other, and at least one, preferably exactly one, fungicide B.

According to another preferred embodiment of the invention, the composition comprises as component A at least three, preferably exactly three, herbicides A different from each other, and at least one, preferably exactly one, fungicide B.

According to another preferred embodiment of the invention, the composition comprises as only active components at least one, preferably exactly one, herbicide A, and at least one, preferably exactly one, fungicide B.

Particularly preferred are the compositions 1.1 to 1.2294, comprising at least one herbicide A and at least one fungicide B, preferably comprising the herbicide A and the fungicide B, as defined in the respective row of table 1. The compound numbers (A.x for herbicide A; B.x for fungicide B) correspond to the compound numbers given above in the list of herbicides A and fungicides B to be used according to the present invention.

TABLE 1
(compositions 1.1. to 1.2294)

| No | herb. A | fung. B |
|---|---|---|
| 1.1 | A.1 | B.1 |
| 1.2 | A.1 | B.2 |
| 1.3 | A.1 | B.3 |
| 1.4 | A.1 | B.4 |
| 1.5 | A.1 | B.5 |
| 1.6 | A.1 | B.6 |
| 1.7 | A.1 | B.7 |
| 1.8 | A.1 | B.8 |
| 1.9 | A.1 | B.9 |
| 1.10 | A.1 | B.10 |
| 1.11 | A.1 | B.11 |
| 1.12 | A.1 | B.12 |
| 1.13 | A.1 | B.13 |
| 1.14 | A.1 | B.14 |
| 1.15 | A.1 | B.15 |
| 1.16 | A.1 | B.16 |
| 1.17 | A.1 | B.17 |
| 1.18 | A.1 | B.18 |
| 1.19 | A.1 | B.19 |
| 1.20 | A.1 | B.20 |
| 1.21 | A.1 | B.21 |
| 1.22 | A.1 | B.22 |
| 1.23 | A.1 | B.23 |
| 1.24 | A.1 | B.24 |
| 1.25 | A.1 | B.25 |
| 1.26 | A.1 | B.26 |
| 1.27 | A.1 | B.27 |
| 1.28 | A.1 | B.28 |
| 1.29 | A.1 | B.29 |
| 1.30 | A.1 | B.30 |
| 1.31 | A.1 | B.31 |
| 1.32 | A.2 | B.1 |
| 1.33 | A.2 | B.2 |
| 1.34 | A.2 | B.3 |
| 1.35 | A.2 | B.4 |
| 1.36 | A.2 | B.5 |
| 1.37 | A.2 | B.6 |
| 1.38 | A.2 | B.7 |
| 1.39 | A.2 | B.8 |
| 1.40 | A.2 | B.9 |
| 1.41 | A.2 | B.10 |
| 1.42 | A.2 | B.11 |
| 1.43 | A.2 | B.12 |
| 1.44 | A.2 | B.13 |
| 1.45 | A.2 | B.14 |
| 1.46 | A.2 | B.15 |
| 1.47 | A.2 | B.16 |
| 1.48 | A.2 | B.17 |
| 1.49 | A.2 | B.18 |
| 1.50 | A.2 | B.19 |
| 1.51 | A.2 | B.20 |
| 1.52 | A.2 | B.21 |
| 1.53 | A.2 | B.22 |
| 1.54 | A.2 | B.23 |
| 1.55 | A.2 | B.24 |
| 1.56 | A.2 | B.25 |
| 1.57 | A.2 | B.26 |
| 1.58 | A.2 | B.27 |
| 1.59 | A.2 | B.28 |
| 1.60 | A.2 | B.29 |
| 1.61 | A.2 | B.30 |
| 1.62 | A.2 | B.31 |
| 1.63 | A.3 | B.1 |
| 1.64 | A.3 | B.2 |
| 1.65 | A.3 | B.3 |
| 1.66 | A.3 | B.4 |
| 1.67 | A.3 | B.5 |
| 1.68 | A.3 | B.6 |
| 1.69 | A.3 | B.7 |
| 1.70 | A.3 | B.8 |
| 1.71 | A.3 | B.9 |
| 1.72 | A.3 | B.10 |
| 1.73 | A.3 | B.11 |
| 1.74 | A.3 | B.12 |
| 1.75 | A.3 | B.13 |
| 1.76 | A.3 | B.14 |
| 1.77 | A.3 | B.15 |
| 1.78 | A.3 | B.16 |
| 1.79 | A.3 | B.17 |
| 1.80 | A.3 | B.18 |
| 1.81 | A.3 | B.19 |
| 1.82 | A.3 | B.20 |
| 1.83 | A.3 | B.21 |
| 1.84 | A.3 | B.22 |
| 1.85 | A.3 | B.23 |
| 1.86 | A.3 | B.24 |
| 1.87 | A.3 | B.25 |
| 1.88 | A.3 | B.26 |
| 1.89 | A.3 | B.27 |
| 1.90 | A.3 | B.28 |
| 1.91 | A.3 | B.29 |
| 1.92 | A.3 | B.30 |
| 1.93 | A.3 | B.31 |
| 1.94 | A.4 | B.1 |
| 1.95 | A.4 | B.2 |
| 1.96 | A.4 | B.3 |
| 1.97 | A.4 | B.4 |
| 1.98 | A.4 | B.5 |
| 1.99 | A.4 | B.6 |
| 1.100 | A.4 | B.7 |
| 1.101 | A.4 | B.8 |
| 1.102 | A.4 | B.9 |
| 1.103 | A.4 | B.10 |
| 1.104 | A.4 | B.11 |
| 1.105 | A.4 | B.12 |
| 1.106 | A.4 | B.13 |
| 1.107 | A.4 | B.14 |
| 1.108 | A.4 | B.15 |
| 1.109 | A.4 | B.16 |
| 1.110 | A.4 | B.17 |
| 1.111 | A.4 | B.18 |
| 1.112 | A.4 | B.19 |
| 1.113 | A.4 | B.20 |
| 1.114 | A.4 | B.21 |
| 1.115 | A.4 | B.22 |
| 1.116 | A.4 | B.23 |
| 1.117 | A.4 | B.24 |
| 1.118 | A.4 | B.25 |
| 1.119 | A.4 | B.26 |
| 1.120 | A.4 | B.27 |
| 1.121 | A.4 | B.28 |
| 1.122 | A.4 | B.29 |
| 1.123 | A.4 | B.30 |
| 1.124 | A.4 | B.31 |
| 1.125 | A.5 | B.1 |
| 1.126 | A.5 | B.2 |
| 1.127 | A.5 | B.3 |
| 1.128 | A.5 | B.4 |
| 1.129 | A.5 | B.5 |
| 1.130 | A.5 | B.6 |
| 1.131 | A.5 | B.7 |
| 1.132 | A.5 | B.8 |
| 1.133 | A.5 | B.9 |
| 1.134 | A.5 | B.10 |
| 1.135 | A.5 | B.11 |
| 1.136 | A.5 | B.12 |
| 1.137 | A.5 | B.13 |
| 1.138 | A.5 | B.14 |
| 1.139 | A.5 | B.15 |
| 1.140 | A.5 | B.16 |
| 1.141 | A.5 | B.17 |
| 1.142 | A.5 | B.18 |
| 1.143 | A.5 | B.19 |
| 1.144 | A.5 | B.20 |
| 1.145 | A.5 | B.21 |
| 1.146 | A.5 | B.22 |
| 1.147 | A.5 | B.23 |
| 1.148 | A.5 | B.24 |
| 1.149 | A.5 | B.25 |
| 1.150 | A.5 | B.26 |
| 1.151 | A.5 | B.27 |
| 1.152 | A.5 | B.28 |
| 1.153 | A.5 | B.29 |
| 1.154 | A.5 | B.30 |
| 1.155 | A.5 | B.31 |
| 1.156 | A.6 | B.1 |
| 1.157 | A.6 | B.2 |
| 1.158 | A.6 | B.3 |
| 1.159 | A.6 | B.4 |
| 1.160 | A.6 | B.5 |
| 1.161 | A.6 | B.6 |
| 1.162 | A.6 | B.7 |
| 1.163 | A.6 | B.8 |
| 1.164 | A.6 | B.9 |
| 1.165 | A.6 | B.10 |
| 1.166 | A.6 | B.11 |
| 1.167 | A.6 | B.12 |
| 1.168 | A.6 | B.13 |
| 1.169 | A.6 | B.14 |
| 1.170 | A.6 | B.15 |
| 1.171 | A.6 | B.16 |
| 1.172 | A.6 | B.17 |
| 1.173 | A.6 | B.18 |
| 1.174 | A.6 | B.19 |
| 1.175 | A.6 | B.20 |
| 1.176 | A.6 | B.21 |
| 1.177 | A.6 | B.22 |
| 1.178 | A.6 | B.23 |
| 1.179 | A.6 | B.24 |
| 1.180 | A.6 | B.25 |
| 1.181 | A.6 | B.26 |
| 1.182 | A.6 | B.27 |
| 1.183 | A.6 | B.28 |
| 1.184 | A.6 | B.29 |
| 1.185 | A.6 | B.30 |
| 1.186 | A.6 | B.31 |
| 1.187 | A.7 | B.1 |
| 1.188 | A.7 | B.2 |
| 1.189 | A.7 | B.3 |
| 1.190 | A.7 | B.4 |
| 1.191 | A.7 | B.5 |
| 1.192 | A.7 | B.6 |
| 1.193 | A.7 | B.7 |
| 1.194 | A.7 | B.8 |
| 1.195 | A.7 | B.9 |
| 1.196 | A.7 | B.10 |
| 1.197 | A.7 | B.11 |
| 1.198 | A.7 | B.12 |
| 1.199 | A.7 | B.13 |
| 1.200 | A.7 | B.14 |
| 1.201 | A.7 | B.15 |
| 1.202 | A.7 | B.16 |
| 1.203 | A.7 | B.17 |
| 1.204 | A.7 | B.18 |
| 1.205 | A.7 | B.19 |
| 1.206 | A.7 | B.20 |
| 1.207 | A.7 | B.21 |
| 1.208 | A.7 | B.22 |
| 1.209 | A.7 | B.23 |
| 1.210 | A.7 | B.24 |
| 1.211 | A.7 | B.25 |
| 1.212 | A.7 | B.26 |
| 1.213 | A.7 | B.27 |
| 1.214 | A.7 | B.28 |
| 1.215 | A.7 | B.29 |
| 1.216 | A.7 | B.30 |
| 1.217 | A.7 | B.31 |
| 1.218 | A.8 | B.1 |
| 1.219 | A.8 | B.2 |
| 1.220 | A.8 | B.3 |
| 1.221 | A.8 | B.4 |
| 1.222 | A.8 | B.5 |
| 1.223 | A.8 | B.6 |
| 1.224 | A.8 | B.7 |
| 1.225 | A.8 | B.8 |
| 1.226 | A.8 | B.9 |
| 1.227 | A.8 | B.10 |
| 1.228 | A.8 | B.11 |
| 1.229 | A.8 | B.12 |
| 1.230 | A.8 | B.13 |
| 1.231 | A.8 | B.14 |
| 1.232 | A.8 | B.15 |
| 1.233 | A.8 | B.16 |
| 1.234 | A.8 | B.17 |
| 1.235 | A.8 | B.18 |
| 1.236 | A.8 | B.19 |
| 1.237 | A.8 | B.20 |
| 1.238 | A.8 | B.21 |
| 1.239 | A.8 | B.22 |
| 1.240 | A.8 | B.23 |
| 1.241 | A.8 | B.24 |
| 1.242 | A.8 | B.25 |
| 1.243 | A.8 | B.26 |
| 1.244 | A.8 | B.27 |
| 1.245 | A.8 | B.28 |
| 1.246 | A.8 | B.29 |
| 1.247 | A.8 | B.30 |
| 1.248 | A.8 | B.31 |
| 1.249 | A.9 | B.1 |
| 1.250 | A.9 | B.2 |
| 1.251 | A.9 | B.3 |
| 1.252 | A.9 | B.4 |
| 1.253 | A.9 | B.5 |
| 1.254 | A.9 | B.6 |
| 1.255 | A.9 | B.7 |
| 1.256 | A.9 | B.8 |
| 1.257 | A.9 | B.9 |
| 1.258 | A.9 | B.10 |
| 1.259 | A.9 | B.11 |
| 1.260 | A.9 | B.12 |
| 1.261 | A.9 | B.13 |
| 1.262 | A.9 | B.14 |
| 1.263 | A.9 | B.15 |
| 1.264 | A.9 | B.16 |
| 1.265 | A.9 | B.17 |
| 1.266 | A.9 | B.18 |
| 1.267 | A.9 | B.19 |
| 1.268 | A.9 | B.20 |
| 1.269 | A.9 | B.21 |
| 1.270 | A.9 | B.22 |
| 1.271 | A.9 | B.23 |
| 1.272 | A.9 | B.24 |
| 1.273 | A.9 | B.25 |
| 1.274 | A.9 | B.26 |
| 1.275 | A.9 | B.27 |
| 1.276 | A.9 | B.28 |
| 1.277 | A.9 | B.29 |
| 1.278 | A.9 | B.30 |
| 1.279 | A.9 | B.31 |
| 1.280 | A.10 | B.1 |
| 1.281 | A.10 | B.2 |
| 1.282 | A.10 | B.3 |
| 1.283 | A.10 | B.4 |
| 1.284 | A.10 | B.5 |
| 1.285 | A.10 | B.6 |
| 1.286 | A.10 | B.7 |
| 1.287 | A.10 | B.8 |
| 1.288 | A.10 | B.9 |
| 1.289 | A.10 | B.10 |
| 1.290 | A.10 | B.11 |
| 1.291 | A.10 | B.12 |
| 1.292 | A.10 | B.13 |
| 1.293 | A.10 | B.14 |
| 1.294 | A.10 | B.15 |
| 1.295 | A.10 | B.16 |
| 1.296 | A.10 | B.17 |
| 1.297 | A.10 | B.18 |
| 1.298 | A.10 | B.19 |
| 1.299 | A.10 | B.20 |
| 1.300 | A.10 | B.21 |
| 1.301 | A.10 | B.22 |
| 1.302 | A.10 | B.23 |
| 1.303 | A.10 | B.24 |
| 1.304 | A.10 | B.25 |
| 1.305 | A.10 | B.26 |
| 1.306 | A.10 | B.27 |
| 1.307 | A.10 | B.28 |
| 1.308 | A.10 | B.29 |
| 1.309 | A.10 | B.30 |
| 1.310 | A.10 | B.31 |
| 1.311 | A.11 | B.1 |
| 1.312 | A.11 | B.2 |
| 1.313 | A.11 | B.3 |
| 1.314 | A.11 | B.4 |
| 1.315 | A.11 | B.5 |
| 1.316 | A.11 | B.6 |
| 1.317 | A.11 | B.7 |
| 1.318 | A.11 | B.8 |
| 1.319 | A.11 | B.9 |
| 1.320 | A.11 | B.10 |
| 1.321 | A.11 | B.11 |
| 1.322 | A.11 | B.12 |
| 1.323 | A.11 | B.13 |
| 1.324 | A.11 | B.14 |
| 1.325 | A.11 | B.15 |
| 1.326 | A.11 | B.16 |
| 1.327 | A.11 | B.17 |
| 1.328 | A.11 | B.18 |
| 1.329 | A.11 | B.19 |
| 1.330 | A.11 | B.20 |
| 1.331 | A.11 | B.21 |
| 1.332 | A.11 | B.22 |
| 1.333 | A.11 | B.23 |
| 1.334 | A.11 | B.24 |
| 1.335 | A.11 | B.25 |
| 1.336 | A.11 | B.26 |
| 1.337 | A.11 | B.27 |
| 1.338 | A.11 | B.28 |
| 1.339 | A.11 | B.29 |
| 1.340 | A.11 | B.30 |
| 1.341 | A.11 | B.31 |
| 1.342 | A.12 | B.1 |
| 1.343 | A.12 | B.2 |
| 1.344 | A.12 | B.3 |
| 1.345 | A.12 | B.4 |
| 1.346 | A.12 | B.5 |
| 1.347 | A.12 | B.6 |
| 1.348 | A.12 | B.7 |
| 1.349 | A.12 | B.8 |
| 1.350 | A.12 | B.9 |
| 1.351 | A.12 | B.10 |
| 1.352 | A.12 | B.11 |
| 1.353 | A.12 | B.12 |
| 1.354 | A.12 | B.13 |
| 1.355 | A.12 | B.14 |
| 1.356 | A.12 | B.15 |
| 1.357 | A.12 | B.16 |
| 1.358 | A.12 | B.17 |
| 1.359 | A.12 | B.18 |
| 1.360 | A.12 | B.19 |
| 1.361 | A.12 | B.20 |
| 1.362 | A.12 | B.21 |
| 1.363 | A.12 | B.22 |
| 1.364 | A.12 | B.23 |
| 1.365 | A.12 | B.24 |
| 1.366 | A.12 | B.25 |
| 1.367 | A.12 | B.26 |
| 1.368 | A.12 | B.27 |
| 1.369 | A.12 | B.28 |
| 1.370 | A.12 | B.29 |
| 1.371 | A.12 | B.30 |
| 1.372 | A.12 | B.31 |
| 1.373 | A.13 | B.1 |
| 1.374 | A.13 | B.2 |
| 1.375 | A.13 | B.3 |
| 1.376 | A.13 | B.4 |
| 1.377 | A.13 | B.5 |
| 1.378 | A.13 | B.6 |
| 1.379 | A.13 | B.7 |
| 1.380 | A.13 | B.8 |
| 1.381 | A.13 | B.9 |
| 1.382 | A.13 | B.10 |
| 1.383 | A.13 | B.11 |
| 1.384 | A.13 | B.12 |
| 1.385 | A.13 | B.13 |
| 1.386 | A.13 | B.14 |
| 1.387 | A.13 | B.15 |
| 1.388 | A.13 | B.16 |
| 1.389 | A.13 | B.17 |
| 1.390 | A.13 | B.18 |
| 1.391 | A.13 | B.19 |
| 1.392 | A.13 | B.20 |
| 1.393 | A.13 | B.21 |
| 1.394 | A.13 | B.22 |
| 1.395 | A.13 | B.23 |
| 1.396 | A.13 | B.24 |
| 1.397 | A.13 | B.25 |
| 1.398 | A.13 | B.26 |
| 1.399 | A.13 | B.27 |
| 1.400 | A.13 | B.28 |
| 1.401 | A.13 | B.29 |
| 1.402 | A.13 | B.30 |
| 1.403 | A.13 | B.31 |
| 1.404 | A.14 | B.1 |
| 1.405 | A.14 | B.2 |
| 1.406 | A.14 | B.3 |
| 1.407 | A.14 | B.4 |
| 1.408 | A.14 | B.5 |
| 1.409 | A.14 | B.6 |
| 1.410 | A.14 | B.7 |
| 1.411 | A.14 | B.8 |
| 1.412 | A.14 | B.9 |
| 1.413 | A.14 | B.10 |
| 1.414 | A.14 | B.11 |
| 1.415 | A.14 | B.12 |
| 1.416 | A.14 | B.13 |
| 1.417 | A.14 | B.14 |
| 1.418 | A.14 | B.15 |
| 1.419 | A.14 | B.16 |
| 1.420 | A.14 | B.17 |
| 1.421 | A.14 | B.18 |
| 1.422 | A.14 | B.19 |
| 1.423 | A.14 | B.20 |
| 1.424 | A.14 | B.21 |
| 1.425 | A.14 | B.22 |
| 1.426 | A.14 | B.23 |
| 1.427 | A.14 | B.24 |
| 1.428 | A.14 | B.25 |
| 1.429 | A.14 | B.26 |
| 1.430 | A.14 | B.27 |
| 1.431 | A.14 | B.28 |
| 1.432 | A.14 | B.29 |
| 1.433 | A.14 | B.30 |
| 1.434 | A.14 | B.31 |
| 1.435 | A.15 | B.1 |
| 1.436 | A.15 | B.2 |
| 1.437 | A.15 | B.3 |
| 1.438 | A.15 | B.4 |
| 1.439 | A.15 | B.5 |
| 1.440 | A.15 | B.6 |
| 1.441 | A.15 | B.7 |
| 1.442 | A.15 | B.8 |
| 1.443 | A.15 | B.9 |
| 1.444 | A.15 | B.10 |
| 1.445 | A.15 | B.11 |
| 1.446 | A.15 | B.12 |
| 1.447 | A.15 | B.13 |
| 1.448 | A.15 | B.14 |
| 1.449 | A.15 | B.15 |
| 1.450 | A.15 | B.16 |
| 1.451 | A.15 | B.17 |
| 1.452 | A.15 | B.18 |
| 1.453 | A.15 | B.19 |
| 1.454 | A.15 | B.20 |
| 1.455 | A.15 | B.21 |
| 1.456 | A.15 | B.22 |
| 1.457 | A.15 | B.23 |
| 1.458 | A.15 | B.24 |
| 1.459 | A.15 | B.25 |
| 1.460 | A.15 | B.26 |
| 1.461 | A.15 | B.27 |
| 1.462 | A.15 | B.28 |
| 1.463 | A.15 | B.29 |
| 1.464 | A.15 | B.30 |
| 1.465 | A.15 | B.31 |
| 1.466 | A.16 | B.1 |
| 1.467 | A.16 | B.2 |
| 1.468 | A.16 | B.3 |
| 1.469 | A.16 | B.4 |
| 1.470 | A.16 | B.5 |
| 1.471 | A.16 | B.6 |
| 1.472 | A.16 | B.7 |
| 1.473 | A.16 | B.8 |
| 1.474 | A.16 | B.9 |
| 1.475 | A.16 | B.10 |
| 1.476 | A.16 | B.11 |
| 1.477 | A.16 | B.12 |
| 1.478 | A.16 | B.13 |
| 1.479 | A.16 | B.14 |
| 1.480 | A.16 | B.15 |
| 1.481 | A.16 | B.16 |
| 1.482 | A.16 | B.17 |
| 1.483 | A.16 | B.18 |
| 1.484 | A.16 | B.19 |
| 1.485 | A.16 | B.20 |
| 1.486 | A.16 | B.21 |
| 1.487 | A.16 | B.22 |
| 1.488 | A.16 | B.23 |
| 1.489 | A.16 | B.24 |
| 1.490 | A.16 | B.25 |
| 1.491 | A.16 | B.26 |
| 1.492 | A.16 | B.27 |
| 1.493 | A.16 | B.28 |
| 1.494 | A.16 | B.29 |
| 1.495 | A.16 | B.30 |
| 1.496 | A.16 | B.31 |
| 1.497 | A.17 | B.1 |
| 1.498 | A.17 | B.2 |
| 1.499 | A.17 | B.3 |
| 1.500 | A.17 | B.4 |
| 1.501 | A.17 | B.5 |
| 1.502 | A.17 | B.6 |
| 1.503 | A.17 | B.7 |
| 1.504 | A.17 | B.8 |
| 1.505 | A.17 | B.9 |
| 1.506 | A.17 | B.10 |
| 1.507 | A.17 | B.11 |
| 1.508 | A.17 | B.12 |
| 1.509 | A.17 | B.13 |
| 1.510 | A.17 | B.14 |
| 1.511 | A.17 | B.15 |
| 1.512 | A.17 | B.16 |
| 1.513 | A.17 | B.17 |
| 1.514 | A.17 | B.18 |
| 1.515 | A.17 | B.19 |
| 1.516 | A.17 | B.20 |
| 1.517 | A.17 | B.21 |
| 1.518 | A.17 | B.22 |
| 1.519 | A.17 | B.23 |
| 1.520 | A.17 | B.24 |
| 1.521 | A.17 | B.25 |
| 1.522 | A.17 | B.26 |
| 1.523 | A.17 | B.27 |
| 1.524 | A.17 | B.28 |
| 1.525 | A.17 | B.29 |
| 1.526 | A.17 | B.30 |
| 1.527 | A.17 | B.31 |
| 1.528 | A.18 | B.1 |
| 1.529 | A.18 | B.2 |
| 1.530 | A.18 | B.3 |
| 1.531 | A.18 | B.4 |
| 1.532 | A.18 | B.5 |
| 1.533 | A.18 | B.6 |
| 1.534 | A.18 | B.7 |
| 1.535 | A.18 | B.8 |
| 1.536 | A.18 | B.9 |
| 1.537 | A.18 | B.10 |
| 1.538 | A.18 | B.11 |
| 1.539 | A.18 | B.12 |
| 1.540 | A.18 | B.13 |
| 1.541 | A.18 | B.14 |
| 1.542 | A.18 | B.15 |
| 1.543 | A.18 | B.16 |
| 1.544 | A.18 | B.17 |
| 1.545 | A.18 | B.18 |
| 1.546 | A.18 | B.19 |
| 1.547 | A.18 | B.20 |
| 1.548 | A.18 | B.21 |
| 1.549 | A.18 | B.22 |
| 1.550 | A.18 | B.23 |
| 1.551 | A.18 | B.24 |
| 1.552 | A.18 | B.25 |
| 1.553 | A.18 | B.26 |
| 1.554 | A.18 | B.27 |
| 1.555 | A.18 | B.28 |
| 1.556 | A.18 | B.29 |
| 1.557 | A.18 | B.30 |
| 1.558 | A.18 | B.31 |
| 1.559 | A.19 | B.1 |
| 1.560 | A.19 | B.2 |
| 1.561 | A.19 | B.3 |
| 1.562 | A.19 | B.4 |
| 1.563 | A.19 | B.5 |
| 1.564 | A.19 | B.6 |
| 1.565 | A.19 | B.7 |
| 1.566 | A.19 | B.8 |
| 1.567 | A.19 | B.9 |
| 1.568 | A.19 | B.10 |
| 1.569 | A.19 | B.11 |
| 1.570 | A.19 | B.12 |
| 1.571 | A.19 | B.13 |
| 1.572 | A.19 | B.14 |
| 1.573 | A.19 | B.15 |
| 1.574 | A.19 | B.16 |
| 1.575 | A.19 | B.17 |
| 1.576 | A.19 | B.18 |
| 1.577 | A.19 | B.19 |
| 1.578 | A.19 | B.20 |
| 1.579 | A.19 | B.21 |
| 1.580 | A.19 | B.22 |
| 1.581 | A.19 | B.23 |
| 1.582 | A.19 | B.24 |
| 1.583 | A.19 | B.25 |
| 1.584 | A.19 | B.26 |
| 1.585 | A.19 | B.27 |
| 1.586 | A.19 | B.28 |
| 1.587 | A.19 | B.29 |
| 1.588 | A.19 | B.30 |
| 1.589 | A.19 | B.31 |
| 1.590 | A.20 | B.1 |
| 1.591 | A.20 | B.2 |
| 1.592 | A.20 | B.3 |
| 1.593 | A.20 | B.4 |
| 1.594 | A.20 | B.5 |
| 1.595 | A.20 | B.6 |
| 1.596 | A.20 | B.7 |
| 1.597 | A.20 | B.8 |
| 1.598 | A.20 | B.9 |
| 1.599 | A.20 | B.10 |
| 1.600 | A.20 | B.11 |
| 1.601 | A.20 | B.12 |
| 1.602 | A.20 | B.13 |
| 1.603 | A.20 | B.14 |
| 1.604 | A.20 | B.15 |
| 1.605 | A.20 | B.16 |
| 1.606 | A.20 | B.17 |
| 1.607 | A.20 | B.18 |
| 1.608 | A.20 | B.19 |
| 1.609 | A.20 | B.20 |
| 1.610 | A.20 | B.21 |
| 1.611 | A.20 | B.22 |
| 1.612 | A.20 | B.23 |
| 1.613 | A.20 | B.24 |
| 1.614 | A.20 | B.25 |
| 1.615 | A.20 | B.26 |
| 1.616 | A.20 | B.27 |
| 1.617 | A.20 | B.28 |
| 1.618 | A.20 | B.29 |
| 1.619 | A.20 | B.30 |
| 1.620 | A.20 | B.31 |
| 1.621 | A.21 | B.1 |
| 1.622 | A.21 | B.2 |
| 1.623 | A.21 | B.3 |
| 1.624 | A.21 | B.4 |
| 1.625 | A.21 | B.5 |
| 1.626 | A.21 | B.6 |
| 1.627 | A.21 | B.7 |
| 1.628 | A.21 | B.8 |
| 1.629 | A.21 | B.9 |
| 1.630 | A.21 | B.10 |
| 1.631 | A.21 | B.11 |
| 1.632 | A.21 | B.12 |
| 1.633 | A.21 | B.13 |
| 1.634 | A.21 | B.14 |
| 1.635 | A.21 | B.15 |
| 1.636 | A.21 | B.16 |
| 1.637 | A.21 | B.17 |
| 1.638 | A.21 | B.18 |
| 1.639 | A.21 | B.19 |
| 1.640 | A.21 | B.20 |
| 1.641 | A.21 | B.21 |
| 1.642 | A.21 | B.22 |
| 1.643 | A.21 | B.23 |
| 1.644 | A.21 | B.24 |
| 1.645 | A.21 | B.25 |
| 1.646 | A.21 | B.26 |
| 1.647 | A.21 | B.27 |
| 1.648 | A.21 | B.28 |
| 1.649 | A.21 | B.29 |
| 1.650 | A.21 | B.30 |
| 1.651 | A.21 | B.31 |
| 1.652 | A.22 | B.1 |
| 1.653 | A.22 | B.2 |
| 1.654 | A.22 | B.3 |
| 1.655 | A.22 | B.4 |
| 1.656 | A.22 | B.5 |
| 1.657 | A.22 | B.6 |
| 1.658 | A.22 | B.7 |
| 1.659 | A.22 | B.8 |
| 1.660 | A.22 | B.9 |
| 1.661 | A.22 | B.10 |
| 1.662 | A.22 | B.11 |
| 1.663 | A.22 | B.12 |
| 1.664 | A.22 | B.13 |
| 1.665 | A.22 | B.14 |
| 1.666 | A.22 | B.15 |
| 1.667 | A.22 | B.16 |
| 1.668 | A.22 | B.17 |
| 1.669 | A.22 | B.18 |
| 1.670 | A.22 | B.19 |
| 1.671 | A.22 | B.20 |
| 1.672 | A.22 | B.21 |
| 1.673 | A.22 | B.22 |
| 1.674 | A.22 | B.23 |
| 1.675 | A.22 | B.24 |
| 1.676 | A.22 | B.25 |
| 1.677 | A.22 | B.26 |
| 1.678 | A.22 | B.27 |
| 1.679 | A.22 | B.28 |
| 1.680 | A.22 | B.29 |
| 1.681 | A.22 | B.30 |
| 1.682 | A.22 | B.31 |
| 1.683 | A.23 | B.1 |
| 1.684 | A.23 | B.2 |
| 1.685 | A.23 | B.3 |
| 1.686 | A.23 | B.4 |
| 1.687 | A.23 | B.5 |
| 1.688 | A.23 | B.6 |
| 1.689 | A.23 | B.7 |
| 1.690 | A.23 | B.8 |
| 1.691 | A.23 | B.9 |
| 1.692 | A.23 | B.10 |
| 1.693 | A.23 | B.11 |
| 1.694 | A.23 | B.12 |
| 1.695 | A.23 | B.13 |
| 1.696 | A.23 | B.14 |
| 1.697 | A.23 | B.15 |
| 1.698 | A.23 | B.16 |
| 1.699 | A.23 | B.17 |
| 1.700 | A.23 | B.18 |
| 1.701 | A.23 | B.19 |
| 1.702 | A.23 | B.20 |
| 1.703 | A.23 | B.21 |
| 1.704 | A.23 | B.22 |
| 1.705 | A.23 | B.23 |
| 1.706 | A.23 | B.24 |
| 1.707 | A.23 | B.25 |
| 1.708 | A.23 | B.26 |
| 1.709 | A.23 | B.27 |
| 1.710 | A.23 | B.28 |
| 1.711 | A.23 | B.29 |
| 1.712 | A.23 | B.30 |
| 1.713 | A.23 | B.31 |
| 1.714 | A.24 | B.1 |
| 1.715 | A.24 | B.2 |
| 1.716 | A.24 | B.3 |
| 1.717 | A.24 | B.4 |
| 1.718 | A.24 | B.5 |
| 1.719 | A.24 | B.6 |
| 1.720 | A.24 | B.7 |
| 1.721 | A.24 | B.8 |
| 1.722 | A.24 | B.9 |
| 1.723 | A.24 | B.10 |
| 1.724 | A.24 | B.11 |
| 1.725 | A.24 | B.12 |
| 1.726 | A.24 | B.13 |
| 1.727 | A.24 | B.14 |
| 1.728 | A.24 | B.15 |
| 1.729 | A.24 | B.16 |
| 1.730 | A.24 | B.17 |
| 1.731 | A.24 | B.18 |
| 1.732 | A.24 | B.19 |
| 1.733 | A.24 | B.20 |
| 1.734 | A.24 | B.21 |
| 1.735 | A.24 | B.22 |
| 1.736 | A.24 | B.23 |
| 1.737 | A.24 | B.24 |
| 1.738 | A.24 | B.25 |
| 1.739 | A.24 | B.26 |
| 1.740 | A.24 | B.27 |
| 1.741 | A.24 | B.28 |
| 1.742 | A.24 | B.29 |
| 1.743 | A.24 | B.30 |
| 1.744 | A.24 | B.31 |
| 1.745 | A.25 | B.1 |
| 1.746 | A.25 | B.2 |
| 1.747 | A.25 | B.3 |
| 1.748 | A.25 | B.4 |
| 1.749 | A.25 | B.5 |
| 1.750 | A.25 | B.6 |
| 1.751 | A.25 | B.7 |
| 1.752 | A.25 | B.8 |
| 1.753 | A.25 | B.9 |
| 1.754 | A.25 | B.10 |
| 1.755 | A.25 | B.11 |
| 1.756 | A.25 | B.12 |
| 1.757 | A.25 | B.13 |
| 1.758 | A.25 | B.14 |
| 1.759 | A.25 | B.15 |
| 1.760 | A.25 | B.16 |
| 1.761 | A.25 | B.17 |
| 1.762 | A.25 | B.18 |
| 1.763 | A.25 | B.19 |
| 1.764 | A.25 | B.20 |
| 1.765 | A.25 | B.21 |
| 1.766 | A.25 | B.22 |
| 1.767 | A.25 | B.23 |
| 1.768 | A.25 | B.24 |
| 1.769 | A.25 | B.25 |
| 1.770 | A.25 | B.26 |
| 1.771 | A.25 | B.27 |
| 1.772 | A.25 | B.28 |
| 1.773 | A.25 | B.29 |
| 1.774 | A.25 | B.30 |
| 1.775 | A.25 | B.31 |
| 1.776 | A.26 | B.1 |
| 1.777 | A.26 | B.2 |
| 1.778 | A.26 | B.3 |
| 1.779 | A.26 | B.4 |
| 1.780 | A.26 | B.5 |
| 1.781 | A.26 | B.6 |
| 1.782 | A.26 | B.7 |
| 1.783 | A.26 | B.8 |
| 1.784 | A.26 | B.9 |
| 1.785 | A.26 | B.10 |
| 1.786 | A.26 | B.11 |
| 1.787 | A.26 | B.12 |
| 1.788 | A.26 | B.13 |
| 1.789 | A.26 | B.14 |
| 1.790 | A.26 | B.15 |
| 1.791 | A.26 | B.16 |
| 1.792 | A.26 | B.17 |
| 1.793 | A.26 | B.18 |
| 1.794 | A.26 | B.19 |
| 1.795 | A.26 | B.20 |
| 1.796 | A.26 | B.21 |
| 1.797 | A.26 | B.22 |
| 1.798 | A.26 | B.23 |
| 1.799 | A.26 | B.24 |
| 1.800 | A.26 | B.25 |
| 1.801 | A.26 | B.26 |
| 1.802 | A.26 | B.27 |
| 1.803 | A.26 | B.28 |
| 1.804 | A.26 | B.29 |
| 1.805 | A.26 | B.30 |
| 1.806 | A.26 | B.31 |
| 1.807 | A.27 | B.1 |
| 1.808 | A.27 | B.2 |
| 1.809 | A.27 | B.3 |
| 1.810 | A.27 | B.4 |
| 1.811 | A.27 | B.5 |
| 1.812 | A.27 | B.6 |
| 1.813 | A.27 | B.7 |
| 1.814 | A.27 | B.8 |
| 1.815 | A.27 | B.9 |
| 1.816 | A.27 | B.10 |
| 1.817 | A.27 | B.11 |
| 1.818 | A.27 | B.12 |
| 1.819 | A.27 | B.13 |
| 1.820 | A.27 | B.14 |
| 1.821 | A.27 | B.15 |
| 1.822 | A.27 | B.16 |
| 1.823 | A.27 | B.17 |
| 1.824 | A.27 | B.18 |
| 1.825 | A.27 | B.19 |
| 1.826 | A.27 | B.20 |
| 1.827 | A.27 | B.21 |
| 1.828 | A.27 | B.22 |
| 1.829 | A.27 | B.23 |
| 1.830 | A.27 | B.24 |
| 1.831 | A.27 | B.25 |
| 1.832 | A.27 | B.26 |
| 1.833 | A.27 | B.27 |
| 1.834 | A.27 | B.28 |
| 1.835 | A.27 | B.29 |
| 1.836 | A.27 | B.30 |
| 1.837 | A.27 | B.31 |
| 1.838 | A.28 | B.1 |
| 1.839 | A.28 | B.2 |
| 1.840 | A.28 | B.3 |
| 1.841 | A.28 | B.4 |
| 1.842 | A.28 | B.5 |
| 1.843 | A.28 | B.6 |
| 1.844 | A.28 | B.7 |
| 1.845 | A.28 | B.8 |
| 1.846 | A.28 | B.9 |
| 1.847 | A.28 | B.10 |
| 1.848 | A.28 | B.11 |
| 1.849 | A.28 | B.12 |
| 1.850 | A.28 | B.13 |
| 1.851 | A.28 | B.14 |
| 1.852 | A.28 | B.15 |
| 1.853 | A.28 | B.16 |
| 1.854 | A.28 | B.17 |
| 1.855 | A.28 | B.18 |
| 1.856 | A.28 | B.19 |
| 1.857 | A.28 | B.20 |
| 1.858 | A.28 | B.21 |
| 1.859 | A.28 | B.22 |
| 1.860 | A.28 | B.23 |
| 1.861 | A.28 | B.24 |
| 1.862 | A.28 | B.25 |
| 1.863 | A.28 | B.26 |
| 1.864 | A.28 | B.27 |
| 1.865 | A.28 | B.28 |
| 1.866 | A.28 | B.29 |
| 1.867 | A.28 | B.30 |
| 1.868 | A.28 | B.31 |
| 1.869 | A.29 | B.1 |
| 1.870 | A.29 | B.2 |
| 1.871 | A.29 | B.3 |
| 1.872 | A.29 | B.4 |
| 1.873 | A.29 | B.5 |
| 1.874 | A.29 | B.6 |
| 1.875 | A.29 | B.7 |
| 1.876 | A.29 | B.8 |
| 1.877 | A.29 | B.9 |
| 1.878 | A.29 | B.10 |
| 1.879 | A.29 | B.11 |
| 1.880 | A.29 | B.12 |
| 1.881 | A.29 | B.13 |
| 1.882 | A.29 | B.14 |
| 1.883 | A.29 | B.15 |
| 1.884 | A.29 | B.16 |
| 1.885 | A.29 | B.17 |
| 1.886 | A.29 | B.18 |
| 1.887 | A.29 | B.19 |
| 1.888 | A.29 | B.20 |
| 1.889 | A.29 | B.21 |
| 1.890 | A.29 | B.22 |
| 1.891 | A.29 | B.23 |
| 1.892 | A.29 | B.24 |
| 1.893 | A.29 | B.25 |
| 1.894 | A.29 | B.26 |
| 1.895 | A.29 | B.27 |
| 1.896 | A.29 | B.28 |
| 1.897 | A.29 | B.29 |
| 1.898 | A.29 | B.30 |
| 1.899 | A.29 | B.31 |
| 1.900 | A.30 | B.1 |
| 1.901 | A.30 | B.2 |
| 1.902 | A.30 | B.3 |
| 1.903 | A.30 | B.4 |
| 1.904 | A.30 | B.5 |
| 1.905 | A.30 | B.6 |
| 1.906 | A.30 | B.7 |
| 1.907 | A.30 | B.8 |
| 1.908 | A.30 | B.9 |
| 1.909 | A.30 | B.10 |
| 1.910 | A.30 | B.11 |
| 1.911 | A.30 | B.12 |
| 1.912 | A.30 | B.13 |
| 1.913 | A.30 | B.14 |
| 1.914 | A.30 | B.15 |
| 1.915 | A.30 | B.16 |
| 1.916 | A.30 | B.17 |
| 1.917 | A.30 | B.18 |
| 1.918 | A.30 | B.19 |
| 1.919 | A.30 | B.20 |
| 1.920 | A.30 | B.21 |
| 1.921 | A.30 | B.22 |
| 1.922 | A.30 | B.23 |
| 1.923 | A.30 | B.24 |
| 1.924 | A.30 | B.25 |
| 1.925 | A.30 | B.26 |
| 1.926 | A.30 | B.27 |
| 1.927 | A.30 | B.28 |
| 1.928 | A.30 | B.29 |
| 1.929 | A.30 | B.30 |
| 1.930 | A.30 | B.31 |
| 1.931 | A.31 | B.1 |
| 1.932 | A.31 | B.2 |
| 1.933 | A.31 | B.3 |
| 1.934 | A.31 | B.4 |
| 1.935 | A.31 | B.5 |
| 1.936 | A.31 | B.6 |
| 1.937 | A.31 | B.7 |
| 1.938 | A.31 | B.8 |
| 1.939 | A.31 | B.9 |
| 1.940 | A.31 | B.10 |
| 1.941 | A.31 | B.11 |
| 1.942 | A.31 | B.12 |
| 1.943 | A.31 | B.13 |
| 1.944 | A.31 | B.14 |
| 1.945 | A.31 | B.15 |
| 1.946 | A.31 | B.16 |
| 1.947 | A.31 | B.17 |
| 1.948 | A.31 | B.18 |
| 1.949 | A.31 | B.19 |
| 1.950 | A.31 | B.20 |
| 1.951 | A.31 | B.21 |
| 1.952 | A.31 | B.22 |
| 1.953 | A.31 | B.23 |
| 1.954 | A.31 | B.24 |
| 1.955 | A.31 | B.25 |
| 1.956 | A.31 | B.26 |
| 1.957 | A.31 | B.27 |
| 1.958 | A.31 | B.28 |
| 1.959 | A.31 | B.29 |
| 1.960 | A.31 | B.30 |
| 1.961 | A.31 | B.31 |
| 1.962 | A.32 | B.1 |
| 1.963 | A.32 | B.2 |
| 1.964 | A.32 | B.3 |
| 1.965 | A.32 | B.4 |
| 1.966 | A.32 | B.5 |
| 1.967 | A.32 | B.6 |
| 1.968 | A.32 | B.7 |
| 1.969 | A.32 | B.8 |
| 1.970 | A.32 | B.9 |
| 1.971 | A.32 | B.10 |
| 1.972 | A.32 | B.11 |
| 1.973 | A.32 | B.12 |
| 1.974 | A.32 | B.13 |
| 1.975 | A.32 | B.14 |
| 1.976 | A.32 | B.15 |
| 1.977 | A.32 | B.16 |
| 1.978 | A.32 | B.17 |
| 1.979 | A.32 | B.18 |
| 1.980 | A.32 | B.19 |
| 1.981 | A.32 | B.20 |
| 1.982 | A.32 | B.21 |
| 1.983 | A.32 | B.22 |
| 1.984 | A.32 | B.23 |
| 1.985 | A.32 | B.24 |
| 1.986 | A.32 | B.25 |
| 1.987 | A.32 | B.26 |
| 1.988 | A.32 | B.27 |
| 1.989 | A.32 | B.28 |
| 1.990 | A.32 | B.29 |
| 1.991 | A.32 | B.30 |
| 1.992 | A.32 | B.31 |
| 1.993 | A.33 | B.1 |
| 1.994 | A.33 | B.2 |
| 1.995 | A.33 | B.3 |
| 1.996 | A.33 | B.4 |
| 1.997 | A.33 | B.5 |
| 1.998 | A.33 | B.6 |
| 1.999 | A.33 | B.7 |
| 1.1000 | A.33 | B.8 |
| 1.1001 | A.33 | B.9 |
| 1.1002 | A.33 | B.10 |
| 1.1003 | A.33 | B.11 |
| 1.1004 | A.33 | B.12 |
| 1.1005 | A.33 | B.13 |
| 1.1006 | A.33 | B.14 |
| 1.1007 | A.33 | B.15 |
| 1.1008 | A.33 | B.16 |
| 1.1009 | A.33 | B.17 |
| 1.1010 | A.33 | B.18 |
| 1.1011 | A.33 | B.19 |
| 1.1012 | A.33 | B.20 |
| 1.1013 | A.33 | B.21 |
| 1.1014 | A.33 | B.22 |
| 1.1015 | A.33 | B.23 |
| 1.1016 | A.33 | B.24 |
| 1.1017 | A.33 | B.25 |
| 1.1018 | A.33 | B.26 |
| 1.1019 | A.33 | B.27 |
| 1.1020 | A.33 | B.28 |
| 1.1021 | A.33 | B.29 |
| 1.1022 | A.33 | B.30 |
| 1.1023 | A.33 | B.31 |
| 1.1024 | A.34 | B.1 |
| 1.1025 | A.34 | B.2 |
| 1.1026 | A.34 | B.3 |
| 1.1027 | A.34 | B.4 |
| 1.1028 | A.34 | B.5 |
| 1.1029 | A.34 | B.6 |
| 1.1030 | A.34 | B.7 |
| 1.1031 | A.34 | B.8 |
| 1.1032 | A.34 | B.9 |
| 1.1033 | A.34 | B.10 |
| 1.1034 | A.34 | B.11 |
| 1.1035 | A.34 | B.12 |
| 1.1036 | A.34 | B.13 |
| 1.1037 | A.34 | B.14 |
| 1.1038 | A.34 | B.15 |
| 1.1039 | A.34 | B.16 |
| 1.1040 | A.34 | B.17 |
| 1.1041 | A.34 | B.18 |
| 1.1042 | A.34 | B.19 |
| 1.1043 | A.34 | B.20 |
| 1.1044 | A.34 | B.21 |
| 1.1045 | A.34 | B.22 |
| 1.1046 | A.34 | B.23 |
| 1.1047 | A.34 | B.24 |
| 1.1048 | A.34 | B.25 |
| 1.1049 | A.34 | B.26 |
| 1.1050 | A.34 | B.27 |
| 1.1051 | A.34 | B.28 |
| 1.1052 | A.34 | B.29 |
| 1.1053 | A.34 | B.30 |
| 1.1054 | A.34 | B.31 |
| 1.1055 | A.35 | B.1 |
| 1.1056 | A.35 | B.2 |
| 1.1057 | A.35 | B.3 |
| 1.1058 | A.35 | B.4 |
| 1.1059 | A.35 | B.5 |
| 1.1060 | A.35 | B.6 |
| 1.1061 | A.35 | B.7 |
| 1.1062 | A.35 | B.8 |
| 1.1063 | A.35 | B.9 |
| 1.1064 | A.35 | B.10 |
| 1.1065 | A.35 | B.11 |
| 1.1066 | A.35 | B.12 |
| 1.1067 | A.35 | B.13 |
| 1.1068 | A.35 | B.14 |
| 1.1069 | A.35 | B.15 |
| 1.1070 | A.35 | B.16 |
| 1.1071 | A.35 | B.17 |
| 1.1072 | A.35 | B.18 |
| 1.1073 | A.35 | B.19 |
| 1.1074 | A.35 | B.20 |
| 1.1075 | A.35 | B.21 |
| 1.1076 | A.35 | B.22 |
| 1.1077 | A.35 | B.23 |
| 1.1078 | A.35 | B.24 |
| 1.1079 | A.35 | B.25 |
| 1.1080 | A.35 | B.26 |
| 1.1081 | A.35 | B.27 |
| 1.1082 | A.35 | B.28 |
| 1.1083 | A.35 | B.29 |
| 1.1084 | A.35 | B.30 |
| 1.1085 | A.35 | B.31 |
| 1.1086 | A.36 | B.1 |
| 1.1087 | A.36 | B.2 |
| 1.1088 | A.36 | B.3 |
| 1.1089 | A.36 | B.4 |
| 1.1090 | A.36 | B.5 |
| 1.1091 | A.36 | B.6 |
| 1.1092 | A.36 | B.7 |
| 1.1093 | A.36 | B.8 |
| 1.1094 | A.36 | B.9 |
| 1.1095 | A.36 | B.10 |
| 1.1096 | A.36 | B.11 |
| 1.1097 | A.36 | B.12 |
| 1.1098 | A.36 | B.13 |
| 1.1099 | A.36 | B.14 |
| 1.1100 | A.36 | B.15 |
| 1.1101 | A.36 | B.16 |
| 1.1102 | A.36 | B.17 |
| 1.1103 | A.36 | B.18 |
| 1.1104 | A.36 | B.19 |
| 1.1105 | A.36 | B.20 |
| 1.1106 | A.36 | B.21 |
| 1.1107 | A.36 | B.22 |
| 1.1108 | A.36 | B.23 |
| 1.1109 | A.36 | B.24 |
| 1.1110 | A.36 | B.25 |
| 1.1111 | A.36 | B.26 |
| 1.1112 | A.36 | B.27 |
| 1.1113 | A.36 | B.28 |
| 1.1114 | A.36 | B.29 |
| 1.1115 | A.36 | B.30 |
| 1.1116 | A.36 | B.31 |
| 1.1117 | A.37 | B.1 |
| 1.1118 | A.37 | B.2 |
| 1.1119 | A.37 | B.3 |
| 1.1120 | A.37 | B.4 |
| 1.1121 | A.37 | B.5 |
| 1.1122 | A.37 | B.6 |
| 1.1123 | A.37 | B.7 |
| 1.1124 | A.37 | B.8 |
| 1.1125 | A.37 | B.9 |
| 1.1126 | A.37 | B.10 |
| 1.1127 | A.37 | B.11 |
| 1.1128 | A.37 | B.12 |
| 1.1129 | A.37 | B.13 |
| 1.1130 | A.37 | B.14 |
| 1.1131 | A.37 | B.15 |
| 1.1132 | A.37 | B.16 |
| 1.1133 | A.37 | B.17 |
| 1.1134 | A.37 | B.18 |
| 1.1135 | A.37 | B.19 |
| 1.1136 | A.37 | B.20 |
| 1.1137 | A.37 | B.21 |
| 1.1138 | A.37 | B.22 |
| 1.1139 | A.37 | B.23 |
| 1.1140 | A.37 | B.24 |
| 1.1141 | A.37 | B.25 |
| 1.1142 | A.37 | B.26 |
| 1.1143 | A.37 | B.27 |
| 1.1144 | A.37 | B.28 |
| 1.1145 | A.37 | B.29 |
| 1.1146 | A.37 | B.30 |
| 1.1147 | A.37 | B.31 |
| 1.1148 | A.38 | B.1 |
| 1.1149 | A.38 | B.2 |
| 1.1150 | A.38 | B.3 |
| 1.1151 | A.38 | B.4 |
| 1.1152 | A.38 | B.5 |
| 1.1153 | A.38 | B.6 |
| 1.1154 | A.38 | B.7 |
| 1.1155 | A.38 | B.8 |
| 1.1156 | A.38 | B.9 |
| 1.1157 | A.38 | B.10 |
| 1.1158 | A.38 | B.11 |
| 1.1159 | A.38 | B.12 |
| 1.1160 | A.38 | B.13 |
| 1.1161 | A.38 | B.14 |
| 1.1162 | A.38 | B.15 |
| 1.1163 | A.38 | B.16 |
| 1.1164 | A.38 | B.17 |
| 1.1165 | A.38 | B.18 |
| 1.1166 | A.38 | B.19 |
| 1.1167 | A.38 | B.20 |
| 1.1168 | A.38 | B.21 |
| 1.1169 | A.38 | B.22 |
| 1.1170 | A.38 | B.23 |
| 1.1171 | A.38 | B.24 |
| 1.1172 | A.38 | B.25 |
| 1.1173 | A.38 | B.26 |
| 1.1174 | A.38 | B.27 |
| 1.1175 | A.38 | B.28 |
| 1.1176 | A.38 | B.29 |
| 1.1177 | A.38 | B.30 |
| 1.1178 | A.38 | B.31 |
| 1.1179 | A.39 | B.1 |
| 1.1180 | A.39 | B.2 |
| 1.1181 | A.39 | B.3 |
| 1.1182 | A.39 | B.4 |
| 1.1183 | A.39 | B.5 |
| 1.1184 | A.39 | B.6 |
| 1.1185 | A.39 | B.7 |
| 1.1186 | A.39 | B.8 |
| 1.1187 | A.39 | B.9 |
| 1.1188 | A.39 | B.10 |
| 1.1189 | A.39 | B.11 |
| 1.1190 | A.39 | B.12 |
| 1.1191 | A.39 | B.13 |
| 1.1192 | A.39 | B.14 |
| 1.1193 | A.39 | B.15 |
| 1.1194 | A.39 | B.16 |
| 1.1195 | A.39 | B.17 |
| 1.1196 | A.39 | B.18 |
| 1.1197 | A.39 | B.19 |
| 1.1198 | A.39 | B.20 |
| 1.1199 | A.39 | B.21 |
| 1.1200 | A.39 | B.22 |
| 1.1201 | A.39 | B.23 |
| 1.1202 | A.39 | B.24 |
| 1.1203 | A.39 | B.25 |
| 1.1204 | A.39 | B.26 |
| 1.1205 | A.39 | B.27 |
| 1.1206 | A.39 | B.28 |
| 1.1207 | A.39 | B.29 |
| 1.1208 | A.39 | B.30 |
| 1.1209 | A.39 | B.31 |
| 1.1210 | A.40 | B.1 |
| 1.1211 | A.40 | B.2 |
| 1.1212 | A.40 | B.3 |
| 1.1213 | A.40 | B.4 |
| 1.1214 | A.40 | B.5 |
| 1.1215 | A.40 | B.6 |
| 1.1216 | A.40 | B.7 |
| 1.1217 | A.40 | B.8 |
| 1.1218 | A.40 | B.9 |
| 1.1219 | A.40 | B.10 |
| 1.1220 | A.40 | B.11 |
| 1.1221 | A.40 | B.12 |
| 1.1222 | A.40 | B.13 |
| 1.1223 | A.40 | B.14 |
| 1.1224 | A.40 | B.15 |
| 1.1225 | A.40 | B.16 |
| 1.1226 | A.40 | B.17 |
| 1.1227 | A.40 | B.18 |
| 1.1228 | A.40 | B.19 |
| 1.1229 | A.40 | B.20 |
| 1.1230 | A.40 | B.21 |
| 1.1231 | A.40 | B.22 |
| 1.1232 | A.40 | B.23 |
| 1.1233 | A.40 | B.24 |
| 1.1234 | A.40 | B.25 |
| 1.1235 | A.40 | B.26 |
| 1.1236 | A.40 | B.27 |
| 1.1237 | A.40 | B.28 |
| 1.1238 | A.40 | B.29 |
| 1.1239 | A.40 | B.30 |
| 1.1240 | A.40 | B.31 |
| 1.1241 | A.41 | B.1 |
| 1.1242 | A.41 | B.2 |
| 1.1243 | A.41 | B.3 |
| 1.1244 | A.41 | B.4 |
| 1.1245 | A.41 | B.5 |
| 1.1246 | A.41 | B.6 |
| 1.1247 | A.41 | B.7 |
| 1.1248 | A.41 | B.8 |
| 1.1249 | A.41 | B.9 |
| 1.1250 | A.41 | B.10 |
| 1.1251 | A.41 | B.11 |
| 1.1252 | A.41 | B.12 |
| 1.1253 | A.41 | B.13 |
| 1.1254 | A.41 | B.14 |
| 1.1255 | A.41 | B.15 |
| 1.1256 | A.41 | B.16 |
| 1.1257 | A.41 | B.17 |
| 1.1258 | A.41 | B.18 |
| 1.1259 | A.41 | B.19 |
| 1.1260 | A.41 | B.20 |
| 1.1261 | A.41 | B.21 |
| 1.1262 | A.41 | B.22 |
| 1.1263 | A.41 | B.23 |
| 1.1264 | A.41 | B.24 |
| 1.1265 | A.41 | B.25 |
| 1.1266 | A.41 | B.26 |
| 1.1267 | A.41 | B.27 |
| 1.1268 | A.41 | B.28 |
| 1.1269 | A.41 | B.29 |
| 1.1270 | A.41 | B.30 |
| 1.1271 | A.41 | B.31 |
| 1.1272 | A.42 | B.1 |
| 1.1273 | A.42 | B.2 |
| 1.1274 | A.42 | B.3 |
| 1.1275 | A.42 | B.4 |
| 1.1276 | A.42 | B.5 |
| 1.1277 | A.42 | B.6 |
| 1.1278 | A.42 | B.7 |
| 1.1279 | A.42 | B.8 |
| 1.1280 | A.42 | B.9 |
| 1.1281 | A.42 | B.10 |
| 1.1282 | A.42 | B.11 |
| 1.1283 | A.42 | B.12 |
| 1.1284 | A.42 | B.13 |
| 1.1285 | A.42 | B.14 |
| 1.1286 | A.42 | B.15 |
| 1.1287 | A.42 | B.16 |
| 1.1288 | A.42 | B.17 |
| 1.1289 | A.42 | B.18 |
| 1.1290 | A.42 | B.19 |
| 1.1291 | A.42 | B.20 |
| 1.1292 | A.42 | B.21 |
| 1.1293 | A.42 | B.22 |
| 1.1294 | A.42 | B.23 |
| 1.1295 | A.42 | B.24 |
| 1.1296 | A.42 | B.25 |
| 1.1297 | A.42 | B.26 |
| 1.1298 | A.42 | B.27 |
| 1.1299 | A.42 | B.28 |
| 1.1300 | A.42 | B.29 |
| 1.1301 | A.42 | B.30 |
| 1.1302 | A.42 | B.31 |
| 1.1303 | A.43 | B.1 |
| 1.1304 | A.43 | B.2 |
| 1.1305 | A.43 | B.3 |
| 1.1306 | A.43 | B.4 |
| 1.1307 | A.43 | B.5 |
| 1.1308 | A.43 | B.6 |
| 1.1309 | A.43 | B.7 |
| 1.1310 | A.43 | B.8 |
| 1.1311 | A.43 | B.9 |
| 1.1312 | A.43 | B.10 |
| 1.1313 | A.43 | B.11 |
| 1.1314 | A.43 | B.12 |
| 1.1315 | A.43 | B.13 |
| 1.1316 | A.43 | B.14 |
| 1.1317 | A.43 | B.15 |
| 1.1318 | A.43 | B.16 |
| 1.1319 | A.43 | B.17 |
| 1.1320 | A.43 | B.18 |
| 1.1321 | A.43 | B.19 |
| 1.1322 | A.43 | B.20 |
| 1.1323 | A.43 | B.21 |
| 1.1324 | A.43 | B.22 |
| 1.1325 | A.43 | B.23 |
| 1.1326 | A.43 | B.24 |
| 1.1327 | A.43 | B.25 |
| 1.1328 | A.43 | B.26 |
| 1.1329 | A.43 | B.27 |
| 1.1330 | A.43 | B.28 |
| 1.1331 | A.43 | B.29 |
| 1.1332 | A.43 | B.30 |
| 1.1333 | A.43 | B.31 |
| 1.1334 | A.44 | B.1 |
| 1.1335 | A.44 | B.2 |
| 1.1336 | A.44 | B.3 |
| 1.1337 | A.44 | B.4 |
| 1.1338 | A.44 | B.5 |
| 1.1339 | A.44 | B.6 |
| 1.1340 | A.44 | B.7 |
| 1.1341 | A.44 | B.8 |
| 1.1342 | A.44 | B.9 |
| 1.1343 | A.44 | B.10 |
| 1.1344 | A.44 | B.11 |
| 1.1345 | A.44 | B.12 |
| 1.1346 | A.44 | B.13 |
| 1.1347 | A.44 | B.14 |
| 1.1348 | A.44 | B.15 |
| 1.1349 | A.44 | B.16 |
| 1.1350 | A.44 | B.17 |
| 1.1351 | A.44 | B.18 |
| 1.1352 | A.44 | B.19 |
| 1.1353 | A.44 | B.20 |
| 1.1354 | A.44 | B.21 |
| 1.1355 | A.44 | B.22 |
| 1.1356 | A.44 | B.23 |
| 1.1357 | A.44 | B.24 |
| 1.1358 | A.44 | B.25 |
| 1.1359 | A.44 | B.26 |
| 1.1360 | A.44 | B.27 |
| 1.1361 | A.44 | B.28 |
| 1.1362 | A.44 | B.29 |
| 1.1363 | A.44 | B.30 |
| 1.1364 | A.44 | B.31 |
| 1.1365 | A.45 | B.1 |
| 1.1366 | A.45 | B.2 |
| 1.1367 | A.45 | B.3 |
| 1.1368 | A.45 | B.4 |
| 1.1369 | A.45 | B.5 |
| 1.1370 | A.45 | B.6 |
| 1.1371 | A.45 | B.7 |
| 1.1372 | A.45 | B.8 |
| 1.1373 | A.45 | B.9 |
| 1.1374 | A.45 | B.10 |
| 1.1375 | A.45 | B.11 |
| 1.1376 | A.45 | B.12 |
| 1.1377 | A.45 | B.13 |
| 1.1378 | A.45 | B.14 |
| 1.1379 | A.45 | B.15 |
| 1.1380 | A.45 | B.16 |
| 1.1381 | A.45 | B.17 |
| 1.1382 | A.45 | B.18 |
| 1.1383 | A.45 | B.19 |
| 1.1384 | A.45 | B.20 |
| 1.1385 | A.45 | B.21 |
| 1.1386 | A.45 | B.22 |
| 1.1387 | A.45 | B.23 |
| 1.1388 | A.45 | B.24 |
| 1.1389 | A.45 | B.25 |
| 1.1390 | A.45 | B.26 |
| 1.1391 | A.45 | B.27 |
| 1.1392 | A.45 | B.28 |
| 1.1393 | A.45 | B.29 |
| 1.1394 | A.45 | B.30 |
| 1.1395 | A.45 | B.31 |
| 1.1396 | A.46 | B.1 |
| 1.1397 | A.46 | B.2 |
| 1.1398 | A.46 | B.3 |
| 1.1399 | A.46 | B.4 |
| 1.1400 | A.46 | B.5 |
| 1.1401 | A.46 | B.6 |
| 1.1402 | A.46 | B.7 |
| 1.1403 | A.46 | B.8 |
| 1.1404 | A.46 | B.9 |
| 1.1405 | A.46 | B.10 |
| 1.1406 | A.46 | B.11 |
| 1.1407 | A.46 | B.12 |
| 1.1408 | A.46 | B.13 |
| 1.1409 | A.46 | B.14 |
| 1.1410 | A.46 | B.15 |
| 1.1411 | A.46 | B.16 |
| 1.1412 | A.46 | B.17 |
| 1.1413 | A.46 | B.18 |
| 1.1414 | A.46 | B.19 |
| 1.1415 | A.46 | B.20 |
| 1.1416 | A.46 | B.21 |
| 1.1417 | A.46 | B.22 |
| 1.1418 | A.46 | B.23 |
| 1.1419 | A.46 | B.24 |
| 1.1420 | A.46 | B.25 |
| 1.1421 | A.46 | B.26 |
| 1.1422 | A.46 | B.27 |
| 1.1423 | A.46 | B.28 |
| 1.1424 | A.46 | B.29 |
| 1.1425 | A.46 | B.30 |
| 1.1426 | A.46 | B.31 |
| 1.1427 | A.47 | B.1 |
| 1.1428 | A.47 | B.2 |
| 1.1429 | A.47 | B.3 |
| 1.1430 | A.47 | B.4 |
| 1.1431 | A.47 | B.5 |
| 1.1432 | A.47 | B.6 |
| 1.1433 | A.47 | B.7 |
| 1.1434 | A.47 | B.8 |
| 1.1435 | A.47 | B.9 |
| 1.1436 | A.47 | B.10 |
| 1.1437 | A.47 | B.11 |
| 1.1438 | A.47 | B.12 |
| 1.1439 | A.47 | B.13 |
| 1.1440 | A.47 | B.14 |
| 1.1441 | A.47 | B.15 |
| 1.1442 | A.47 | B.16 |
| 1.1443 | A.47 | B.17 |
| 1.1444 | A.47 | B.18 |
| 1.1445 | A.47 | B.19 |
| 1.1446 | A.47 | B.20 |
| 1.1447 | A.47 | B.21 |
| 1.1448 | A.47 | B.22 |
| 1.1449 | A.47 | B.23 |
| 1.1450 | A.47 | B.24 |
| 1.1451 | A.47 | B.25 |
| 1.1452 | A.47 | B.26 |
| 1.1453 | A.47 | B.27 |
| 1.1454 | A.47 | B.28 |
| 1.1455 | A.47 | B.29 |
| 1.1456 | A.47 | B.30 |
| 1.1457 | A.47 | B.31 |
| 1.1458 | A.48 | B.1 |
| 1.1459 | A.48 | B.2 |
| 1.1460 | A.48 | B.3 |
| 1.1461 | A.48 | B.4 |
| 1.1462 | A.48 | B.5 |
| 1.1463 | A.48 | B.6 |
| 1.1464 | A.48 | B.7 |
| 1.1465 | A.48 | B.8 |
| 1.1466 | A.48 | B.9 |
| 1.1467 | A.48 | B.10 |
| 1.1468 | A.48 | B.11 |
| 1.1469 | A.48 | B.12 |
| 1.1470 | A.48 | B.13 |
| 1.1471 | A.48 | B.14 |
| 1.1472 | A.48 | B.15 |
| 1.1473 | A.48 | B.16 |
| 1.1474 | A.48 | B.17 |
| 1.1475 | A.48 | B.18 |
| 1.1476 | A.48 | B.19 |
| 1.1477 | A.48 | B.20 |
| 1.1478 | A.48 | B.21 |
| 1.1479 | A.48 | B.22 |
| 1.1480 | A.48 | B.23 |
| 1.1481 | A.48 | B.24 |
| 1.1482 | A.48 | B.25 |
| 1.1483 | A.48 | B.26 |
| 1.1484 | A.48 | B.27 |
| 1.1485 | A.48 | B.28 |
| 1.1486 | A.48 | B.29 |
| 1.1487 | A.48 | B.30 |
| 1.1488 | A.48 | B.31 |
| 1.1489 | A.49 | B.1 |
| 1.1490 | A.49 | B.2 |
| 1.1491 | A.49 | B.3 |
| 1.1492 | A.49 | B.4 |
| 1.1493 | A.49 | B.5 |
| 1.1494 | A.49 | B.6 |
| 1.1495 | A.49 | B.7 |
| 1.1496 | A.49 | B.8 |
| 1.1497 | A.49 | B.9 |
| 1.1498 | A.49 | B.10 |
| 1.1499 | A.49 | B.11 |
| 1.1500 | A.49 | B.12 |
| 1.1501 | A.49 | B.13 |
| 1.1502 | A.49 | B.14 |
| 1.1503 | A.49 | B.15 |
| 1.1504 | A.49 | B.16 |
| 1.1505 | A.49 | B.17 |
| 1.1506 | A.49 | B.18 |
| 1.1507 | A.49 | B.19 |
| 1.1508 | A.49 | B.20 |
| 1.1509 | A.49 | B.21 |
| 1.1510 | A.49 | B.22 |
| 1.1511 | A.49 | B.23 |
| 1.1512 | A.49 | B.24 |
| 1.1513 | A.49 | B.25 |
| 1.1514 | A.49 | B.26 |
| 1.1515 | A.49 | B.27 |
| 1.1516 | A.49 | B.28 |
| 1.1517 | A.49 | B.29 |
| 1.1518 | A.49 | B.30 |
| 1.1519 | A.49 | B.31 |
| 1.1520 | A.50 | B.1 |
| 1.1521 | A.50 | B.2 |
| 1.1522 | A.50 | B.3 |
| 1.1523 | A.50 | B.4 |
| 1.1524 | A.50 | B.5 |
| 1.1525 | A.50 | B.6 |
| 1.1526 | A.50 | B.7 |
| 1.1527 | A.50 | B.8 |
| 1.1528 | A.50 | B.9 |
| 1.1529 | A.50 | B.10 |
| 1.1530 | A.50 | B.11 |
| 1.1531 | A.50 | B.12 |
| 1.1532 | A.50 | B.13 |
| 1.1533 | A.50 | B.14 |
| 1.1534 | A.50 | B.15 |
| 1.1535 | A.50 | B.16 |
| 1.1536 | A.50 | B.17 |
| 1.1537 | A.50 | B.18 |
| 1.1538 | A.50 | B.19 |
| 1.1539 | A.50 | B.20 |
| 1.1540 | A.50 | B.21 |
| 1.1541 | A.50 | B.22 |
| 1.1542 | A.50 | B.23 |
| 1.1543 | A.50 | B.24 |
| 1.1544 | A.50 | B.25 |
| 1.1545 | A.50 | B.26 |
| 1.1546 | A.50 | B.27 |
| 1.1547 | A.50 | B.28 |
| 1.1548 | A.50 | B.29 |
| 1.1549 | A.50 | B.30 |
| 1.1550 | A.50 | B.31 |
| 1.1551 | A.51 | B.1 |
| 1.1552 | A.51 | B.2 |
| 1.1553 | A.51 | B.3 |
| 1.1554 | A.51 | B.4 |
| 1.1555 | A.51 | B.5 |
| 1.1556 | A.51 | B.6 |
| 1.1557 | A.51 | B.7 |
| 1.1558 | A.51 | B.8 |
| 1.1559 | A.51 | B.9 |
| 1.1560 | A.51 | B.10 |
| 1.1561 | A.51 | B.11 |
| 1.1562 | A.51 | B.12 |
| 1.1563 | A.51 | B.13 |
| 1.1564 | A.51 | B.14 |
| 1.1565 | A.51 | B.15 |
| 1.1566 | A.51 | B.16 |
| 1.1567 | A.51 | B.17 |
| 1.1568 | A.51 | B.18 |
| 1.1569 | A.51 | B.19 |
| 1.1570 | A.51 | B.20 |
| 1.1571 | A.51 | B.21 |
| 1.1572 | A.51 | B.22 |
| 1.1573 | A.51 | B.23 |
| 1.1574 | A.51 | B.24 |
| 1.1575 | A.51 | B.25 |
| 1.1576 | A.51 | B.26 |
| 1.1577 | A.51 | B.27 |
| 1.1578 | A.51 | B.28 |
| 1.1579 | A.51 | B.29 |
| 1.1580 | A.51 | B.30 |
| 1.1581 | A.51 | B.31 |
| 1.1582 | A.52 | B.1 |
| 1.1583 | A.52 | B.2 |
| 1.1584 | A.52 | B.3 |
| 1.1585 | A.52 | B.4 |
| 1.1586 | A.52 | B.5 |
| 1.1587 | A.52 | B.6 |
| 1.1588 | A.52 | B.7 |
| 1.1589 | A.52 | B.8 |
| 1.1590 | A.52 | B.9 |
| 1.1591 | A.52 | B.10 |
| 1.1592 | A.52 | B.11 |
| 1.1593 | A.52 | B.12 |
| 1.1594 | A.52 | B.13 |
| 1.1595 | A.52 | B.14 |
| 1.1596 | A.52 | B.15 |
| 1.1597 | A.52 | B.16 |
| 1.1598 | A.52 | B.17 |
| 1.1599 | A.52 | B.18 |
| 1.1600 | A.52 | B.19 |
| 1.1601 | A.52 | B.20 |
| 1.1602 | A.52 | B.21 |
| 1.1603 | A.52 | B.22 |
| 1.1604 | A.52 | B.23 |
| 1.1605 | A.52 | B.24 |
| 1.1606 | A.52 | B.25 |
| 1.1607 | A.52 | B.26 |
| 1.1608 | A.52 | B.27 |
| 1.1609 | A.52 | B.28 |
| 1.1610 | A.52 | B.29 |
| 1.1611 | A.52 | B.30 |
| 1.1612 | A.52 | B.31 |
| 1.1613 | A.53 | B.1 |
| 1.1614 | A.53 | B.2 |
| 1.1615 | A.53 | B.3 |
| 1.1616 | A.53 | B.4 |
| 1.1617 | A.53 | B.5 |
| 1.1618 | A.53 | B.6 |
| 1.1619 | A.53 | B.7 |
| 1.1620 | A.53 | B.8 |
| 1.1621 | A.53 | B.9 |
| 1.1622 | A.53 | B.10 |
| 1.1623 | A.53 | B.11 |
| 1.1624 | A.53 | B.12 |
| 1.1625 | A.53 | B.13 |
| 1.1626 | A.53 | B.14 |
| 1.1627 | A.53 | B.15 |
| 1.1628 | A.53 | B.16 |
| 1.1629 | A.53 | B.17 |
| 1.1630 | A.53 | B.18 |
| 1.1631 | A.53 | B.19 |
| 1.1632 | A.53 | B.20 |
| 1.1633 | A.53 | B.21 |
| 1.1634 | A.53 | B.22 |
| 1.1635 | A.53 | B.23 |
| 1.1636 | A.53 | B.24 |
| 1.1637 | A.53 | B.25 |
| 1.1638 | A.53 | B.26 |
| 1.1639 | A.53 | B.27 |
| 1.1640 | A.53 | B.28 |
| 1.1641 | A.53 | B.29 |
| 1.1642 | A.53 | B.30 |
| 1.1643 | A.53 | B.31 |
| 1.1644 | A.54 | B.1 |
| 1.1645 | A.54 | B.2 |
| 1.1646 | A.54 | B.3 |
| 1.1647 | A.54 | B.4 |
| 1.1648 | A.54 | B.5 |
| 1.1649 | A.54 | B.6 |
| 1.1650 | A.54 | B.7 |
| 1.1651 | A.54 | B.8 |
| 1.1652 | A.54 | B.9 |
| 1.1653 | A.54 | B.10 |
| 1.1654 | A.54 | B.11 |
| 1.1655 | A.54 | B.12 |
| 1.1656 | A.54 | B.13 |
| 1.1657 | A.54 | B.14 |
| 1.1658 | A.54 | B.15 |
| 1.1659 | A.54 | B.16 |
| 1.1660 | A.54 | B.17 |
| 1.1661 | A.54 | B.18 |
| 1.1662 | A.54 | B.19 |
| 1.1663 | A.54 | B.20 |
| 1.1664 | A.54 | B.21 |
| 1.1665 | A.54 | B.22 |
| 1.1666 | A.54 | B.23 |
| 1.1667 | A.54 | B.24 |
| 1.1668 | A.54 | B.25 |
| 1.1669 | A.54 | B.26 |
| 1.1670 | A.54 | B.27 |
| 1.1671 | A.54 | B.28 |
| 1.1672 | A.54 | B.29 |
| 1.1673 | A.54 | B.30 |
| 1.1674 | A.54 | B.31 |
| 1.1675 | A.55 | B.1 |
| 1.1676 | A.55 | B.2 |
| 1.1677 | A.55 | B.3 |
| 1.1678 | A.55 | B.4 |
| 1.1679 | A.55 | B.5 |
| 1.1680 | A.55 | B.6 |
| 1.1681 | A.55 | B.7 |
| 1.1682 | A.55 | B.8 |
| 1.1683 | A.55 | B.9 |
| 1.1684 | A.55 | B.10 |
| 1.1685 | A.55 | B.11 |
| 1.1686 | A.55 | B.12 |
| 1.1687 | A.55 | B.13 |
| 1.1688 | A.55 | B.14 |
| 1.1689 | A.55 | B.15 |
| 1.1690 | A.55 | B.16 |
| 1.1691 | A.55 | B.17 |
| 1.1692 | A.55 | B.18 |
| 1.1693 | A.55 | B.19 |
| 1.1694 | A.55 | B.20 |
| 1.1695 | A.55 | B.21 |
| 1.1696 | A.55 | B.22 |
| 1.1697 | A.55 | B.23 |
| 1.1698 | A.55 | B.24 |
| 1.1699 | A.55 | B.25 |
| 1.1700 | A.55 | B.26 |
| 1.1701 | A.55 | B.27 |
| 1.1702 | A.55 | B.28 |
| 1.1703 | A.55 | B.29 |
| 1.1704 | A.55 | B.30 |
| 1.1705 | A.55 | B.31 |
| 1.1706 | A.56 | B.1 |
| 1.1707 | A.56 | B.2 |
| 1.1708 | A.56 | B.3 |
| 1.1709 | A.56 | B.4 |
| 1.1710 | A.56 | B.5 |
| 1.1711 | A.56 | B.6 |
| 1.1712 | A.56 | B.7 |
| 1.1713 | A.56 | B.8 |
| 1.1714 | A.56 | B.9 |
| 1.1715 | A.56 | B.10 |
| 1.1716 | A.56 | B.11 |
| 1.1717 | A.56 | B.12 |
| 1.1718 | A.56 | B.13 |
| 1.1719 | A.56 | B.14 |
| 1.1720 | A.56 | B.15 |
| 1.1721 | A.56 | B.16 |
| 1.1722 | A.56 | B.17 |
| 1.1723 | A.56 | B.18 |
| 1.1724 | A.56 | B.19 |
| 1.1725 | A.56 | B.20 |
| 1.1726 | A.56 | B.21 |
| 1.1727 | A.56 | B.22 |
| 1.1728 | A.56 | B.23 |
| 1.1729 | A.56 | B.24 |
| 1.1730 | A.56 | B.25 |
| 1.1731 | A.56 | B.26 |
| 1.1732 | A.56 | B.27 |
| 1.1733 | A.56 | B.28 |
| 1.1734 | A.56 | B.29 |
| 1.1735 | A.56 | B.30 |
| 1.1736 | A.56 | B.31 |
| 1.1737 | A.57 | B.1 |
| 1.1738 | A.57 | B.2 |
| 1.1739 | A.57 | B.3 |
| 1.1740 | A.57 | B.4 |
| 1.1741 | A.57 | B.5 |
| 1.1742 | A.57 | B.6 |
| 1.1743 | A.57 | B.7 |
| 1.1744 | A.57 | B.8 |
| 1.1745 | A.57 | B.9 |
| 1.1746 | A.57 | B.10 |
| 1.1747 | A.57 | B.11 |
| 1.1748 | A.57 | B.12 |
| 1.1749 | A.57 | B.13 |
| 1.1750 | A.57 | B.14 |
| 1.1751 | A.57 | B.15 |
| 1.1752 | A.57 | B.16 |
| 1.1753 | A.57 | B.17 |
| 1.1754 | A.57 | B.18 |
| 1.1755 | A.57 | B.19 |
| 1.1756 | A.57 | B.20 |
| 1.1757 | A.57 | B.21 |
| 1.1758 | A.57 | B.22 |
| 1.1759 | A.57 | B.23 |
| 1.1760 | A.57 | B.24 |
| 1.1761 | A.57 | B.25 |
| 1.1762 | A.57 | B.26 |
| 1.1763 | A.57 | B.27 |
| 1.1764 | A.57 | B.28 |
| 1.1765 | A.57 | B.29 |
| 1.1766 | A.57 | B.30 |
| 1.1767 | A.57 | B.31 |
| 1.1768 | A.58 | B.1 |
| 1.1769 | A.58 | B.2 |
| 1.1770 | A.58 | B.3 |
| 1.1771 | A.58 | B.4 |
| 1.1772 | A.58 | B.5 |
| 1.1773 | A.58 | B.6 |
| 1.1774 | A.58 | B.7 |
| 1.1775 | A.58 | B.8 |
| 1.1776 | A.58 | B.9 |
| 1.1777 | A.58 | B.10 |
| 1.1778 | A.58 | B.11 |
| 1.1779 | A.58 | B.12 |
| 1.1780 | A.58 | B.13 |
| 1.1781 | A.58 | B.14 |
| 1.1782 | A.58 | B.15 |
| 1.1783 | A.58 | B.16 |
| 1.1784 | A.58 | B.17 |
| 1.1785 | A.58 | B.18 |
| 1.1786 | A.58 | B.19 |
| 1.1787 | A.58 | B.20 |
| 1.1788 | A.58 | B.21 |
| 1.1789 | A.58 | B.22 |
| 1.1790 | A.58 | B.23 |
| 1.1791 | A.58 | B.24 |
| 1.1792 | A.58 | B.25 |
| 1.1793 | A.58 | B.26 |
| 1.1794 | A.58 | B.27 |
| 1.1795 | A.58 | B.28 |
| 1.1796 | A.58 | B.29 |
| 1.1797 | A.58 | B.30 |
| 1.1798 | A.58 | B.31 |
| 1.1799 | A.59 | B.1 |
| 1.1800 | A.59 | B.2 |
| 1.1801 | A.59 | B.3 |
| 1.1802 | A.59 | B.4 |
| 1.1803 | A.59 | B.5 |
| 1.1804 | A.59 | B.6 |
| 1.1805 | A.59 | B.7 |
| 1.1806 | A.59 | B.8 |
| 1.1807 | A.59 | B.9 |
| 1.1808 | A.59 | B.10 |
| 1.1809 | A.59 | B.11 |
| 1.1810 | A.59 | B.12 |
| 1.1811 | A.59 | B.13 |
| 1.1812 | A.59 | B.14 |
| 1.1813 | A.59 | B.15 |
| 1.1814 | A.59 | B.16 |
| 1.1815 | A.59 | B.17 |
| 1.1816 | A.59 | B.18 |
| 1.1817 | A.59 | B.19 |
| 1.1818 | A.59 | B.20 |
| 1.1819 | A.59 | B.21 |
| 1.1820 | A.59 | B.22 |
| 1.1821 | A.59 | B.23 |
| 1.1822 | A.59 | B.24 |
| 1.1823 | A.59 | B.25 |
| 1.1824 | A.59 | B.26 |
| 1.1825 | A.59 | B.27 |
| 1.1826 | A.59 | B.28 |
| 1.1827 | A.59 | B.29 |
| 1.1828 | A.59 | B.30 |
| 1.1829 | A.59 | B.31 |
| 1.1830 | A.60 | B.1 |
| 1.1831 | A.60 | B.2 |
| 1.1832 | A.60 | B.3 |
| 1.1833 | A.60 | B.4 |
| 1.1834 | A.60 | B.5 |
| 1.1835 | A.60 | B.6 |
| 1.1836 | A.60 | B.7 |
| 1.1837 | A.60 | B.8 |
| 1.1838 | A.60 | B.9 |
| 1.1839 | A.60 | B.10 |
| 1.1840 | A.60 | B.11 |
| 1.1841 | A.60 | B.12 |
| 1.1842 | A.60 | B.13 |
| 1.1843 | A.60 | B.14 |
| 1.1844 | A.60 | B.15 |
| 1.1845 | A.60 | B.16 |
| 1.1846 | A.60 | B.17 |
| 1.1847 | A.60 | B.18 |
| 1.1848 | A.60 | B.19 |
| 1.1849 | A.60 | B.20 |
| 1.1850 | A.60 | B.21 |
| 1.1851 | A.60 | B.22 |
| 1.1852 | A.60 | B.23 |
| 1.1853 | A.60 | B.24 |
| 1.1854 | A.60 | B.25 |
| 1.1855 | A.60 | B.26 |
| 1.1856 | A.60 | B.27 |
| 1.1857 | A.60 | B.28 |
| 1.1858 | A.60 | B.29 |
| 1.1859 | A.60 | B.30 |
| 1.1860 | A.60 | B.31 |
| 1.1861 | A.61 | B.1 |
| 1.1862 | A.61 | B.2 |
| 1.1863 | A.61 | B.3 |
| 1.1864 | A.61 | B.4 |
| 1.1865 | A.61 | B.5 |
| 1.1866 | A.61 | B.6 |
| 1.1867 | A.61 | B.7 |
| 1.1868 | A.61 | B.8 |
| 1.1869 | A.61 | B.9 |
| 1.1870 | A.61 | B.10 |
| 1.1871 | A.61 | B.11 |
| 1.1872 | A.61 | B.12 |
| 1.1873 | A.61 | B.13 |
| 1.1874 | A.61 | B.14 |
| 1.1875 | A.61 | B.15 |
| 1.1876 | A.61 | B.16 |
| 1.1877 | A.61 | B.17 |
| 1.1878 | A.61 | B.18 |
| 1.1879 | A.61 | B.19 |
| 1.1880 | A.61 | B.20 |
| 1.1881 | A.61 | B.21 |
| 1.1882 | A.61 | B.22 |
| 1.1883 | A.61 | B.23 |
| 1.1884 | A.61 | B.24 |
| 1.1885 | A.61 | B.25 |
| 1.1886 | A.61 | B.26 |
| 1.1887 | A.61 | B.27 |
| 1.1888 | A.61 | B.28 |
| 1.1889 | A.61 | B.29 |
| 1.1890 | A.61 | B.30 |
| 1.1891 | A.61 | B.31 |
| 1.1892 | A.62 | B.1 |
| 1.1893 | A.62 | B.2 |
| 1.1894 | A.62 | B.3 |
| 1.1895 | A.62 | B.4 |
| 1.1896 | A.62 | B.5 |
| 1.1897 | A.62 | B.6 |
| 1.1898 | A.62 | B.7 |
| 1.1899 | A.62 | B.8 |
| 1.1900 | A.62 | B.9 |
| 1.1901 | A.62 | B.10 |
| 1.1902 | A.62 | B.11 |
| 1.1903 | A.62 | B.12 |
| 1.1904 | A.62 | B.13 |
| 1.1905 | A.62 | B.14 |
| 1.1906 | A.62 | B.15 |
| 1.1907 | A.62 | B.16 |
| 1.1908 | A.62 | B.17 |
| 1.1909 | A.62 | B.18 |
| 1.1910 | A.62 | B.19 |
| 1.1911 | A.62 | B.20 |
| 1.1912 | A.62 | B.21 |
| 1.1913 | A.62 | B.22 |
| 1.1914 | A.62 | B.23 |
| 1.1915 | A.62 | B.24 |
| 1.1916 | A.62 | B.25 |
| 1.1917 | A.62 | B.26 |
| 1.1918 | A.62 | B.27 |
| 1.1919 | A.62 | B.28 |
| 1.1920 | A.62 | B.29 |
| 1.1921 | A.62 | B.30 |
| 1.1922 | A.62 | B.31 |
| 1.1923 | A.63 | B.1 |
| 1.1924 | A.63 | B.2 |
| 1.1925 | A.63 | B.3 |
| 1.1926 | A.63 | B.4 |
| 1.1927 | A.63 | B.5 |
| 1.1928 | A.63 | B.6 |
| 1.1929 | A.63 | B.7 |
| 1.1930 | A.63 | B.8 |
| 1.1931 | A.63 | B.9 |
| 1.1932 | A.63 | B.10 |
| 1.1933 | A.63 | B.11 |
| 1.1934 | A.63 | B.12 |
| 1.1935 | A.63 | B.13 |
| 1.1936 | A.63 | B.14 |
| 1.1937 | A.63 | B.15 |
| 1.1938 | A.63 | B.16 |
| 1.1939 | A.63 | B.17 |
| 1.1940 | A.63 | B.18 |
| 1.1941 | A.63 | B.19 |
| 1.1942 | A.63 | B.20 |
| 1.1943 | A.63 | B.21 |
| 1.1944 | A.63 | B.22 |
| 1.1945 | A.63 | B.23 |
| 1.1946 | A.63 | B.24 |
| 1.1947 | A.63 | B.25 |
| 1.1948 | A.63 | B.26 |
| 1.1949 | A.63 | B.27 |
| 1.1950 | A.63 | B.28 |
| 1.1951 | A.63 | B.29 |
| 1.1952 | A.63 | B.30 |
| 1.1953 | A.63 | B.31 |
| 1.1954 | A.64 | B.1 |
| 1.1955 | A.64 | B.2 |
| 1.1956 | A.64 | B.3 |
| 1.1957 | A.64 | B.4 |
| 1.1958 | A.64 | B.5 |
| 1.1959 | A.64 | B.6 |
| 1.1960 | A.64 | B.7 |
| 1.1961 | A.64 | B.8 |
| 1.1962 | A.64 | B.9 |
| 1.1963 | A.64 | B.10 |
| 1.1964 | A.64 | B.11 |
| 1.1965 | A.64 | B.12 |
| 1.1966 | A.64 | B.13 |
| 1.1967 | A.64 | B.14 |
| 1.1968 | A.64 | B.15 |
| 1.1969 | A.64 | B.16 |
| 1.1970 | A.64 | B.17 |
| 1.1971 | A.64 | B.18 |
| 1.1972 | A.64 | B.19 |
| 1.1973 | A.64 | B.20 |
| 1.1974 | A.64 | B.21 |
| 1.1975 | A.64 | B.22 |
| 1.1976 | A.64 | B.23 |
| 1.1977 | A.64 | B.24 |
| 1.1978 | A.64 | B.25 |
| 1.1979 | A.64 | B.26 |
| 1.1980 | A.64 | B.27 |
| 1.1981 | A.64 | B.28 |
| 1.1982 | A.64 | B.29 |
| 1.1983 | A.64 | B.30 |
| 1.1984 | A.64 | B.31 |
| 1.1985 | A.65 | B.1 |
| 1.1986 | A.65 | B.2 |
| 1.1987 | A.65 | B.3 |
| 1.1988 | A.65 | B.4 |
| 1.1989 | A.65 | B.5 |
| 1.1990 | A.65 | B.6 |
| 1.1991 | A.65 | B.7 |
| 1.1992 | A.65 | B.8 |
| 1.1993 | A.65 | B.9 |
| 1.1994 | A.65 | B.10 |
| 1.1995 | A.65 | B.11 |
| 1.1996 | A.65 | B.12 |
| 1.1997 | A.65 | B.13 |
| 1.1998 | A.65 | B.14 |
| 1.1999 | A.65 | B.15 |
| 1.2000 | A.65 | B.16 |
| 1.2001 | A.65 | B.17 |
| 1.2002 | A.65 | B.18 |
| 1.2003 | A.65 | B.19 |
| 1.2004 | A.65 | B.20 |
| 1.2005 | A.65 | B.21 |
| 1.2006 | A.65 | B.22 |
| 1.2007 | A.65 | B.23 |
| 1.2008 | A.65 | B.24 |
| 1.2009 | A.65 | B.25 |
| 1.2010 | A.65 | B.26 |
| 1.2011 | A.65 | B.27 |
| 1.2012 | A.65 | B.28 |
| 1.2013 | A.65 | B.29 |
| 1.2014 | A.65 | B.30 |
| 1.2015 | A.65 | B.31 |
| 1.2016 | A.66 | B.1 |
| 1.2017 | A.66 | B.2 |
| 1.2018 | A.66 | B.3 |
| 1.2019 | A.66 | B.4 |
| 1.2020 | A.66 | B.5 |
| 1.2021 | A.66 | B.6 |
| 1.2022 | A.66 | B.7 |
| 1.2023 | A.66 | B.8 |
| 1.2024 | A.66 | B.9 |
| 1.2025 | A.66 | B.10 |
| 1.2026 | A.66 | B.11 |
| 1.2027 | A.66 | B.12 |
| 1.2028 | A.66 | B.13 |
| 1.2029 | A.66 | B.14 |
| 1.2030 | A.66 | B.15 |
| 1.2031 | A.66 | B.16 |
| 1.2032 | A.66 | B.17 |
| 1.2033 | A.66 | B.18 |
| 1.2034 | A.66 | B.19 |
| 1.2035 | A.66 | B.20 |
| 1.2036 | A.66 | B.21 |
| 1.2037 | A.66 | B.22 |
| 1.2038 | A.66 | B.23 |
| 1.2039 | A.66 | B.24 |
| 1.2040 | A.66 | B.25 |
| 1.2041 | A.66 | B.26 |
| 1.2042 | A.66 | B.27 |
| 1.2043 | A.66 | B.28 |
| 1.2044 | A.66 | B.29 |
| 1.2045 | A.66 | B.30 |
| 1.2046 | A.66 | B.31 |
| 1.2047 | A.67 | B.1 |
| 1.2048 | A.67 | B.2 |
| 1.2049 | A.67 | B.3 |
| 1.2050 | A.67 | B.4 |
| 1.2051 | A.67 | B.5 |
| 1.2052 | A.67 | B.6 |
| 1.2053 | A.67 | B.7 |
| 1.2054 | A.67 | B.8 |
| 1.2055 | A.67 | B.9 |
| 1.2056 | A.67 | B.10 |
| 1.2057 | A.67 | B.11 |
| 1.2058 | A.67 | B.12 |
| 1.2059 | A.67 | B.13 |
| 1.2060 | A.67 | B.14 |
| 1.2061 | A.67 | B.15 |
| 1.2062 | A.67 | B.16 |
| 1.2063 | A.67 | B.17 |
| 1.2064 | A.67 | B.18 |
| 1.2065 | A.67 | B.19 |
| 1.2066 | A.67 | B.20 |
| 1.2067 | A.67 | B.21 |
| 1.2068 | A.67 | B.22 |
| 1.2069 | A.67 | B.23 |
| 1.2070 | A.67 | B.24 |
| 1.2071 | A.67 | B.25 |
| 1.2072 | A.67 | B.26 |
| 1.2073 | A.67 | B.27 |
| 1.2074 | A.67 | B.28 |
| 1.2075 | A.67 | B.29 |
| 1.2076 | A.67 | B.30 |
| 1.2077 | A.67 | B.31 |
| 1.2078 | A.68 | B.1 |
| 1.2079 | A.68 | B.2 |
| 1.2080 | A.68 | B.3 |
| 1.2081 | A.68 | B.4 |
| 1.2082 | A.68 | B.5 |
| 1.2083 | A.68 | B.6 |
| 1.2084 | A.68 | B.7 |
| 1.2085 | A.68 | B.8 |
| 1.2086 | A.68 | B.9 |
| 1.2087 | A.68 | B.10 |
| 1.2088 | A.68 | B.11 |
| 1.2089 | A.68 | B.12 |
| 1.2090 | A.68 | B.13 |
| 1.2091 | A.68 | B.14 |
| 1.2092 | A.68 | B.15 |
| 1.2093 | A.68 | B.16 |
| 1.2094 | A.68 | B.17 |
| 1.2095 | A.68 | B.18 |
| 1.2096 | A.68 | B.19 |
| 1.2097 | A.68 | B.20 |
| 1.2098 | A.68 | B.21 |
| 1.2099 | A.68 | B.22 |
| 1.2100 | A.68 | B.23 |
| 1.2101 | A.68 | B.24 |
| 1.2102 | A.68 | B.25 |
| 1.2103 | A.68 | B.26 |
| 1.2104 | A.68 | B.27 |
| 1.2105 | A.68 | B.28 |
| 1.2106 | A.68 | B.29 |
| 1.2107 | A.68 | B.30 |
| 1.2108 | A.68 | B.31 |
| 1.2109 | A.69 | B.1 |
| 1.2110 | A.69 | B.2 |
| 1.2111 | A.69 | B.3 |
| 1.2112 | A.69 | B.4 |
| 1.2113 | A.69 | B.5 |
| 1.2114 | A.69 | B.6 |
| 1.2115 | A.69 | B.7 |
| 1.2116 | A.69 | B.8 |
| 1.2117 | A.69 | B.9 |
| 1.2118 | A.69 | B.10 |
| 1.2119 | A.69 | B.11 |
| 1.2120 | A.69 | B.12 |
| 1.2121 | A.69 | B.13 |
| 1.2122 | A.69 | B.14 |
| 1.2123 | A.69 | B.15 |
| 1.2124 | A.69 | B.16 |
| 1.2125 | A.69 | B.17 |
| 1.2126 | A.69 | B.18 |
| 1.2127 | A.69 | B.19 |
| 1.2128 | A.69 | B.20 |
| 1.2129 | A.69 | B.21 |
| 1.2130 | A.69 | B.22 |
| 1.2131 | A.69 | B.23 |
| 1.2132 | A.69 | B.24 |
| 1.2133 | A.69 | B.25 |
| 1.2134 | A.69 | B.26 |
| 1.2135 | A.69 | B.27 |
| 1.2136 | A.69 | B.28 |
| 1.2137 | A.69 | B.29 |
| 1.2138 | A.69 | B.30 |
| 1.2139 | A.69 | B.31 |
| 1.2140 | A.70 | B.1 |
| 1.2141 | A.70 | B.2 |
| 1.2142 | A.70 | B.3 |
| 1.2143 | A.70 | B.4 |
| 1.2144 | A.70 | B.5 |
| 1.2145 | A.70 | B.6 |
| 1.2146 | A.70 | B.7 |
| 1.2147 | A.70 | B.8 |
| 1.2148 | A.70 | B.9 |
| 1.2149 | A.70 | B.10 |
| 1.2150 | A.70 | B.11 |
| 1.2151 | A.70 | B.12 |
| 1.2152 | A.70 | B.13 |
| 1.2153 | A.70 | B.14 |
| 1.2154 | A.70 | B.15 |
| 1.2155 | A.70 | B.16 |
| 1.2156 | A.70 | B.17 |
| 1.2157 | A.70 | B.18 |
| 1.2158 | A.70 | B.19 |
| 1.2159 | A.70 | B.20 |
| 1.2160 | A.70 | B.21 |
| 1.2161 | A.70 | B.22 |
| 1.2162 | A.70 | B.23 |
| 1.2163 | A.70 | B.24 |
| 1.2164 | A.70 | B.25 |
| 1.2165 | A.70 | B.26 |
| 1.2166 | A.70 | B.27 |
| 1.2167 | A.70 | B.28 |
| 1.2168 | A.70 | B.29 |
| 1.2169 | A.70 | B.30 |
| 1.2170 | A.70 | B.31 |
| 1.2171 | A.71 | B.1 |
| 1.2172 | A.71 | B.2 |
| 1.2173 | A.71 | B.3 |
| 1.2174 | A.71 | B.4 |
| 1.2175 | A.71 | B.5 |
| 1.2176 | A.71 | B.6 |
| 1.2177 | A.71 | B.7 |
| 1.2178 | A.71 | B.8 |
| 1.2179 | A.71 | B.9 |
| 1.2180 | A.71 | B.10 |
| 1.2181 | A.71 | B.11 |
| 1.2182 | A.71 | B.12 |
| 1.2183 | A.71 | B.13 |
| 1.2184 | A.71 | B.14 |
| 1.2185 | A.71 | B.15 |
| 1.2186 | A.71 | B.16 |
| 1.2187 | A.71 | B.17 |
| 1.2188 | A.71 | B.18 |
| 1.2189 | A.71 | B.19 |
| 1.2190 | A.71 | B.20 |
| 1.2191 | A.71 | B.21 |
| 1.2192 | A.71 | B.22 |
| 1.2193 | A.71 | B.23 |
| 1.2194 | A.71 | B.24 |
| 1.2195 | A.71 | B.25 |
| 1.2196 | A.71 | B.26 |
| 1.2197 | A.71 | B.27 |
| 1.2198 | A.71 | B.28 |
| 1.2199 | A.71 | B.29 |
| 1.2200 | A.71 | B.30 |
| 1.2201 | A.71 | B.31 |
| 1.2202 | A.72 | B.1 |
| 1.2203 | A.72 | B.2 |
| 1.2204 | A.72 | B.3 |
| 1.2205 | A.72 | B.4 |
| 1.2206 | A.72 | B.5 |
| 1.2207 | A.72 | B.6 |
| 1.2208 | A.72 | B.7 |
| 1.2209 | A.72 | B.8 |
| 1.2210 | A.72 | B.9 |
| 1.2211 | A.72 | B.10 |
| 1.2212 | A.72 | B.11 |
| 1.2213 | A.72 | B.12 |
| 1.2214 | A.72 | B.13 |
| 1.2215 | A.72 | B.14 |
| 1.2216 | A.72 | B.15 |
| 1.2217 | A.72 | B.16 |
| 1.2218 | A.72 | B.17 |
| 1.2219 | A.72 | B.18 |
| 1.2220 | A.72 | B.19 |
| 1.2221 | A.72 | B.20 |
| 1.2222 | A.72 | B.21 |
| 1.2223 | A.72 | B.22 |
| 1.2224 | A.72 | B.23 |
| 1.2225 | A.72 | B.24 |
| 1.2226 | A.72 | B.25 |
| 1.2227 | A.72 | B.26 |
| 1.2228 | A.72 | B.27 |
| 1.2229 | A.72 | B.28 |
| 1.2230 | A.72 | B.29 |
| 1.2231 | A.72 | B.30 |
| 1.2232 | A.72 | B.31 |
| 1.2233 | A.73 | B.1 |
| 1.2234 | A.73 | B.2 |
| 1.2235 | A.73 | B.3 |
| 1.2236 | A.73 | B.4 |
| 1.2237 | A.73 | B.5 |
| 1.2238 | A.73 | B.6 |
| 1.2239 | A.73 | B.7 |
| 1.2240 | A.73 | B.8 |
| 1.2241 | A.73 | B.9 |
| 1.2242 | A.73 | B.10 |
| 1.2243 | A.73 | B.11 |
| 1.2244 | A.73 | B.12 |
| 1.2245 | A.73 | B.13 |
| 1.2246 | A.73 | B.14 |
| 1.2247 | A.73 | B.15 |
| 1.2248 | A.73 | B.16 |
| 1.2249 | A.73 | B.17 |
| 1.2250 | A.73 | B.18 |
| 1.2251 | A.73 | B.19 |
| 1.2252 | A.73 | B.20 |
| 1.2253 | A.73 | B.21 |
| 1.2254 | A.73 | B.22 |
| 1.2255 | A.73 | B.23 |
| 1.2256 | A.73 | B.24 |
| 1.2257 | A.73 | B.25 |
| 1.2258 | A.73 | B.26 |
| 1.2259 | A.73 | B.27 |
| 1.2260 | A.73 | B.28 |
| 1.2261 | A.73 | B.29 |
| 1.2262 | A.73 | B.30 |
| 1.2263 | A.73 | B.31 |
| 1.2264 | A.74 | B.1 |
| 1.2265 | A.74 | B.2 |
| 1.2266 | A.74 | B.3 |
| 1.2267 | A.74 | B.4 |
| 1.2268 | A.74 | B.5 |
| 1.2269 | A.74 | B.6 |
| 1.2270 | A.74 | B.7 |
| 1.2271 | A.74 | B.8 |
| 1.2272 | A.74 | B.9 |
| 1.2273 | A.74 | B.10 |
| 1.2274 | A.74 | B.11 |
| 1.2275 | A.74 | B.12 |
| 1.2276 | A.74 | B.13 |
| 1.2277 | A.74 | B.14 |
| 1.2278 | A.74 | B.15 |
| 1.2279 | A.74 | B.16 |
| 1.2280 | A.74 | B.17 |
| 1.2281 | A.74 | B.18 |
| 1.2282 | A.74 | B.19 |
| 1.2283 | A.74 | B.20 |
| 1.2284 | A.74 | B.21 |
| 1.2285 | A.74 | B.22 |
| 1.2286 | A.74 | B.23 |
| 1.2287 | A.74 | B.24 |
| 1.2288 | A.74 | B.25 |
| 1.2289 | A.74 | B.26 |
| 1.2290 | A.74 | B.27 |
| 1.2291 | A.74 | B.28 |
| 1.2292 | A.74 | B.29 |
| 1.2293 | A.74 | B.30 |
| 1.2294 | A.74 | B.31 |

Among the above compositions, preference is given to the following:
1.1, 1.4, 1.9, 1.12, 1.13, 1.16, 1.21, 1.22, 1.24, 1.25, 1.26, 1.27, 1.28, 1.29, 1.30, 1.32, 1.35, 1.40, 1.43, 1.44, 1.47, 1.52, 1.53, 1.55, 1.56, 1.57, 1.58, 1.59, 1.60, 1.61, 1.280, 1.283, 1.288, 1.291, 1.292, 1.295, 1.300, 1.301, 1.303, 1.304, 1.305, 1.306, 1.307, 1.308, 1.309, 1.311, 1.314, 1.319, 1.322, 1.323, 1.326, 1.331, 1.332, 1.334, 1.335, 1.336, 1.337, 1.338, 1.339, 1.340, 1.528, 1.531, 1.536, 1.539, 1.540, 1.543, 1.548, 1.549, 1.551, 1.552, 1.553, 1.554, 1.555, 1.556, 1.557, 1.559, 1.562, 1.567, 1.570, 1.571, 1.574, 1.579, 1.580, 1.582, 1.583, 1.584, 1.585, 1.586, 1.587, 1.588, 1.621, 1.624, 1.629, 1.632, 1.633, 1.636, 1.641, 1.642, 1.644, 1.645, 1.646, 1.647, 1.648, 1.649, 1.650, 1.714, 1.717, 1.722, 1.725, 1.726, 1.729, 1.734, 1.735, 1.737, 1.738, 1.739, 1.740, 1.741, 1.742, 1.743, 1.807, 1.810, 1.815, 1.818, 1.819, 1.822, 1.827, 1.828, 1.830, 1.831, 1.832, 1.833, 1.834, 1.835, 1.836, 1.962, 1.965, 1.970, 1.973, 1.974, 1.977, 1.982, 1.983, 1.985, 1.986, 1.987, 1.988, 1.989, 1.990, 1.991, 1.993, 1.996, 1.1001, 1.1004, 1.1005, 1 008, 1.1013, 1.1014, 1.1016, 1.1017, 1.1018, 1.1019, 1.1020, 1.1021, 1.1022, 1.1024, 1.1027, 1.1032, 1.1035, 1.1036, 1.1039, 1.1044, 1.1045, 1.1047, 1.1048, 1.1049, 1.1050, 1.1051, 1.1052, 1.1053, 1.1055, 1.1058, 1.1063, 1.1066, 1.1067, 1.1070, 1.1075, 1.1076, 1.1078, 1.1079, 1.1080, 1.1081, 1.1082, 1.1083, 1.1084, 1.1086, 1.1089, 1.1094, 1.1097, 1.1098, 1.1101, 1.1106, 1.1107, 1.1109, 1.1110, 1.1111, 1.1112, 1.1113, 1.1114, 1.1115, 1.1117, 1.1120, 1.1125, 1.1128, 1.1129, 1.1132, 1.1137, 1.1138, 1.1140, 1.1141, 1.1142, 1.1143, 1.1144, 1.1145, 1.1146, 1.1148, 1.1151, 1.1156, 1.1159, 1.1160, 1.1163, 1.1168, 1.1169, 1.1171, 1.1172, 1.1173, 1.1174, 1.1175, 1.1176, 1.1177, 1.1179, 1.1182, 1.1187, 1.1190, 1.1191, 1.1194, 1.1199, 1.1200, 1.1202, 1.1203, 1.1204, 1.1205, 1.1206, 1.1207, 1.1208, 1.1210, 1.1213, 1.1218, 1.1221, 1.1222, 1.1225, 1.1230, 1.1231, 1.1233, 1.1234, 1.1235, 1.1236, 1.1237, 1.1238, 1.1239, 1.1241, 1.1244, 1.1249, 1.1252, 1.1253, 1.1256, 1.1261, 1.1262, 1.1264, 1.1265, 1.1266, 1.1267, 1.1268, 1.1269, 1.1270, 1.1272, 1.1275, 1.1280, 1.1283, 1.1284, 1.1287, 1.1292, 1.1293, 1.1295, 1.1296, 1.1297, 1.1298, 1.1299, 1.1300, 1.1301, 1.1303, 1.1306, 1.1311, 1.1314, 1.1315, 1.1318, 1.1323, 1.1324, 1.1326, 1.1327, 1.1328, 1.1329, 1.1330, 1.1331, 1.1332, 1.1334, 1.1337, 1.1342, 1.1345, 1.1346, 1.1349, 1.1354, 1.1355, 1.1357, 1.1358, 1.1359, 1.1360, 1.1361, 1.1362, 1.1363, 1.1365, 1.1368, 1.1373, 1.1376, 1.1377, 1.1380, 1.1385, 1.1386, 1.1388, 1.1389, 1.1390, 1.1391, 1.1392, 1.1393, 1.1394, 1.1396, 1.1399, 1.1404, 1.1407, 1.1408, 1.1411, 1.1416, 1.1417, 1.1419, 1.1420, 1.1421, 1.1422, 1.1423, 1.1424, 1.1425, 1.1427, 1.1430, 1.1435, 1.1438, 1.1439, 1.1442, 1.1447, 1.1448, 1.1450, 1.1451, 1.1452, 1.1453, 1.1454, 1.1455, 1.1456, 1.1458, 1.1461, 1.1466, 1.1469, 1.1470, 1.1473, 1.1478, 1.1479, 1.1481, 1.1482, 1.1483, 1.1484, 1.1485, 1.1486, 1.1487, 1.1489, 1.1492, 1.1497, 1.1500, 1.1501, 1.1504, 1.1509, 1.1510, 1.1512, 1.1513, 1.1514, 1.1515, 1.1516, 1.1517, 1.1518, 1.1520, 1.1523, 1.1528, 1.1531, 1.1532, 1.1535, 1.1540, 1.1541, 1.1543, 1.1544, 1.1545, 1.1546, 1.1547, 1.1548, 1.1549, 1.1551, 1.1554, 1.1559, 1.1562, 1.1563, 1.1566, 1.1571, 1.1572, 1.1574, 1.1575, 1.1576, 1.1577, 1.1578, 1.1579, 1.1580, 1.1582, 1.1585, 1.1590, 1.1593, 1.1594, 1.1597, 1.1602, 1.1603, 1.1605, 1.1606, 1.1607, 1.1608, 1.1609, 1.1610, 1.1611, 1.1613, 1.1616, 1.1621, 1.1624, 1.1625, 1.1628, 1.1633, 1.1634, 1.1636, 1.1637, 1.1638, 1.1639, 1.1640, 1.1641, 1.1642, 1.1644, 1.1647, 1.1652, 1.1655, 1.1656, 1.1659, 1.1664, 1.1665, 1.1667, 1.1668, 1.1669, 1.1670, 1.1671, 1.1672, 1.1673, 1.1675, 1.1678, 1.1683, 1.1686, 1.1687, 1.1690, 1.1695, 1.1696, 1.1698, 1.1699, 1.1700, 1.1701, 1.1702, 1.1703, 1.1704, 1.1706, 1.1709, 1.1714, 1.1717, 1.1718, 1.1721, 1.1726, 1.1727, 1.1729, 1.1730, 1.1731, 1.1732, 1.1733, 1.1734, 1.1735, 1.1737, 1.1740, 1.1745, 1.1748, 1.1749, 1.1752, 1.1757, 1.1758, 1.1760, 1.1761, 1.1762, 1.1763, 1.1764, 1.1765, 1.1766, 1.1768, 1.1771, 1.1776, 1.1779, 1.1780, 1.1783, 1.1788, 1.1789, 1.1791, 1.1792, 1.1793, 1.1794, 1.1795, 1.1796, 1.1797, 1.1799, 1.1802, 1.1807, 1.1810, 1.1811, 1.1814, 1.1819, 1.1820, 1.1822, 1.1823, 1.1824, 1.1825, 1.1826, 1.1827, 1.1828, 1.1830, 1.1833, 1.1838, 1.1841, 1.1842, 1.1845, 1.1850, 1.1851, 1.1853, 1.1854, 1.1855, 1.1856, 1.1857, 1.1858, 1.1859, 1.1861, 1.1864, 1.1869, 1.1872, 1.1873, 1.1876, 1.1881, 1.1882, 1.1884, 1.1885, 1.1886, 1.1887, 1.1888, 1.1889, 1.1890, 1.1892, 1.1895, 1.1900, 1.1903, 1.1904, 1.1907, 1.1912, 1.1913, 1.1915, 1.1916, 1.1917, 1.1918, 1.1919, 1.1920, 1.1921, 1.1923, 1.1926, 1.1931, 1.1934, 1.1935, 1.1938, 1.1943, 1.1944, 1.1946, 1.1947, 1.1948, 1.1949, 1.1950, 1.1951, 1.1952, 1.1954, 1.1957, 1.1962, 1.1965, 1.1966, 1.1969, 1.1974, 1.1975, 1.1977, 1.1978, 1.1979, 1.1980, 1.1981, 1.1982, 1.1983, 1.1985, 1.1988, 1.1993, 1.1996, 1.1997, 1.2000, 1.2005, 1.2006, 1.2008, 1.2009, 1.2010, 1.2011, 1.2012, 1.2013, 1.2014, 1.2016, 1.2019, 1.2024, 1.2027, 1.2028, 1.2031, 1.2036, 1.2037, 1.2039, 1.2040, 1.2041, 1.2042, 1.2043, 1.2044, 1.2045, 1.2047, 1.2050, 1.2055, 1.2058, 1.2059, 1.2062, 1.2067, 1.2068, 1.2070, 1.2071, 1.2072, 1.2073, 1.2074, 1.2075, 1.2076, 1.2078, 1.2081, 1.2086, 1.2089, 1.2090, 1.2093, 1.2098, 1.2099, 1.2101, 1.2102, 1.2103, 1.2104, 1.2105, 1.2106, 1.2107, 1.2109, 1.2112, 1.2117, 1.2120, 1.2121, 1.2124, 1.2129, 1.2130, 1.2132, 1.2133, 1.2134, 1.2135, 1.2136, 1.2137, 1.2138, 1.2140, 1.2143, 1.2148, 1.2151, 1.2152, 1.2155, 1.2160, 1.2161, 1.2163, 1.2164, 1.2165, 1.2166, 1.2167, 1.2168, 1.2169, 1.2171, 1.2174, 1.2179, 1.2182, 1.2183, 1.2186, 1.2191, 1.2192, 1.2194, 1.2195, 1.2196, 1.2197, 1.2198, 1.2199, 1.2200, 1.2202, 1.2205, 1.2210, 1.2213, 1.2214, 1.2217, 1.2222, 1.2223, 1.2225, 1.2226, 1.2227, 1.2228, 1.2229, 1.2230, 1.2231, 1.2233, 1.2236, 1.2241, 1.2244, 1.2245, 1.2248, 1.2253, 1.2254, 1.2256, 1.2257, 1.2258, 1.2259, 1.2260, 1.2261, 1.2262, 1.2264, 1.2267, 1.2272, 1.2275, 1.2276, 1.2279, 1.2284, 1.2285, 1.2287, 1.2288, 1.2289, 1.2290, 1.2291, 1.2292, 1.2293.

More preference is given to following compositions:
1.1, 1.4, 1.9, 1.13, 1.16, 1.21, 1.22, 1.24, 1.25, 1.26, 1.27, 1.29, 1.30, 1.32, 1.35, 1.40, 1.44, 1.47, 1.52, 1.53, 1.55, 1.56, 1.57, 1.58, 1.60, 1.61, 1.280, 1.283, 1.288, 1.292, 1.295, 1.300, 1.301, 1.303, 1.304, 1.305, 1.306, 1.308, 1.309, 1.311, 1.314, 1.319, 1.323, 1.326, 1.331, 1.332, 1.334, 1.335, 1.336, 1.337, 1.339, 1.340, 1.528, 1.531, 1.536, 1.540, 1.543, 1.548, 1.549, 1.551, 1.552, 1.553, 1.554, 1.556, 1.557, 1.559, 1.562, 1.567, 1.571, 1.574, 1.579, 1.580, 1.582, 1.583, 1.584, 1.585, 1.587, 1.588, 1.621, 1.624, 1.629, 1.633, 1.636, 1.641, 1.642, 1.644, 1.645, 1.646, 1.647, 1.649, 1.650, 1.714, 1.717, 1.722, 1.726, 1.729, 1.734, 1.735, 1.737, 1.738, 1.739, 1.740, 1.742, 1.743, 1.807, 1.810, 1.815, 1.819, 1.822, 1.827, 1.828, 1.830, 1.831, 1.832, 1.833, 1.835, 1.836, 1.993, 1.996, 1.1001, 1.1005, 1.1008, 1.1013, 1.1014, 1.1016, 1.1017, 1.1018, 1.1019, 1.1021, 1.1022, 1.1086, 1.1089, 1.1094, 1.1098, 1.1101, 1.1106, 1.1107, 1.1109, 1.1110, 1.1111, 1.1112, 1.1114, 1.1115, 1.1117, 1.1120, 1.1125, 1.1129, 1.1132, 1.1137, 1.1138, 1.1140, 1.1141, 1.1142, 1.1143, 1.1145, 1.1146, 1.1179, 1.1182, 1.1187, 1.1191, 1.1194, 1.1199, 1.1200, 1.1202, 1.1203, 1.1204, 1.1205, 1.1207, 1.1208, 1.1241, 1.1244, 1.1249, 1.1253, 1.1256, 1.1261, 1.1262, 1.1264, 1.1265, 1.1266, 1.1267, 1.1269, 1.1270, 1.1272, 1.1275, 1.1280, 1.1284, 1.1287, 1.1292, 1.1293, 1.1295, 1.1296, 1.1297, 1.1298, 1.1300, 1.1301, 1.1334, 1.1337, 1.1342, 1.1346, 1.1349, 1.1354, 1.1355, 1.1357, 1.1358, 1.1359, 1.1360, 1.1362, 1.1363, 1.1365, 1.1368, 1.1373, 1.1377, 1.1380, 1.1385, 1.1386, 1.1388, 1.1389, 1.1390, 1.1391, 1.1393, 1.1394, 1.1396, 1.1399, 1.1404, 1.1408, 1.1411, 1.1416, 1.1417, 1.1419, 1.1420, 1.1421, 1.1422, 1.1424, 1.1425, 1.1427, 1.1430, 1.1435, 1.1439, 1.1442, 1.1447, 1.1448, 1.1450, 1.1451, 1.1452, 1.1453, 1.1455, 1.1456, 1.1644, 1.1647, 1.1652, 1.1656, 1.1659, 1.1664, 1.1665, 1.1667, 1.1668, 1.1669, 1.1670, 1.1672, 1.1673, 1.1799, 1.1802, 1.1807, 1.1811, 1.1814, 1.1819, 1.1820, 1.1822, 1.1823, 1.1824, 1.1825, 1.1827, 1.1828, 1.1830, 1.1833, 1.1838, 1.1842, 1.1845, 1.1850, 1.1851, 1.1853, 1.1854, 1.1855, 1.1856, 1.1858, 1.1859, 1.1861, 1.1864, 1.1869, 1.1873, 1.1876, 1.1881, 1.1882, 1.1884, 1.1885, 1.1886, 1.1887, 1.1889, 1.1890, 1.1892, 1.1895, 1.1900, 1.1904, 1.1907, 1.1912, 1.1913, 1.1915, 1.1916, 1.1917, 1.1918, 1.1920, 1.1921, 1.1923, 1.1926, 1.1931, 1.1935, 1.1938, 1.1943, 1.1944, 1.1946, 1.1947, 1.1948, 1.1949, 1.1951, 1.1952, 1.1954, 1.1957, 1.1962, 1.1966, 1.1969, 1.1974, 1.1975, 1.1977, 1.1978, 1.1979, 1.1980, 1.1982, 1.1983, 1.1985, 1.1988, 1.1993, 1.1997, 1.2000, 1.2005, 1.2006, 1.2008, 1.2009, 1.2010, 1.2011, 1.2013, 1.2014, 1.2016, 1.2019, 1.2024, 1.2028, 1.2031, 1.2036, 1.2037, 1.2039, 1.2040, 1.2041, 1.2042, 1.2044, 1.2045, 1.2109, 1.2112, 1.2117, 1.2121, 1.2124, 1.2129, 1.2130, 1.2132, 1.2133, 1.2134, 1.2135, 1.2137, 1.2138, 1.2140, 1.2143, 1.2148, 1.2152, 1.2155, 1.2160, 1.2161, 1.2163, 1.2164, 1.2165, 1.2166, 1.2168, 1.2169, 1.2171, 1.2174, 1.2179, 1.2183, 1.2186, 1.2191, 1.2192, 1.2194, 1.2195, 1.2196, 1.2197, 1.2199, 1.2200, 1.2202, 1.2205, 1.2210, 1.2214, 1.2217, 1.2222, 1.2223, 1.2225, 1.2226, 1.2227, 1.2228, 1.2230, 1.2231, 1.2233, 1.2236, 1.2241, 1.2245, 1.2248, 1.2253, 1.2254, 1.2256, 1.2257, 1.2258, 1.2259, 1.2261, 1.2262, 1.2264, 1.2267, 1.2272, 1.2276, 1.2279, 1.2284, 1.2285, 1.2287, 1.2288, 1.2289, 1.2290, 1.2292, 1.2293.

It may be useful to apply the compositions according to the present invention comprising at least one the herbicide A and the at least one fungicide B in combination with safeners. Accordingly in another embodiment of the present invention the compositions according to the present invention comprise as additional component at least one safener C.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The at least one safener C and at least one the herbicide A and at least one fungicide B can be applied simultaneously or in succession.

Suitable safeners C are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Especially preferred safeners C are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)-amino]benzenesulfonamide (CAS 129531-12-0).

Particularly preferred safeners C are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

The safeners C are known safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998.

The assignment of the active compounds to the respective mechanisms of action is based on current knowledge. If several mechanisms of action apply to one active compound, this substance was only assigned to one mechanism of action.

If the herbicide A, the fungicide B and/or the safener C are capable of forming geometrical isomers, for example E/Z isomers, both the pure isomers and mixtures thereof may be used in the compositions according to the invention. If the herbicide A and/or the fungicide B have one of more centers of chirality and are thus present as enantiomers or diastereomers, both the pure enantiomers and diastereomers and mixtures thereof may be used in the compositions according to the invention.

The herbicide A, the fungicide B and/or the safener C can be present in different crystal modifications whose biological activity may differ. They are likewise subject matter of the present invention.

If the herbicide A, the fungicide B and/or the safener C have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyeth-1-oxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

The herbicide A, the fungicide B and/or the safener C having a carboxyl group can be employed in the form of the acid, in the form of an agriculturally suitable salt or else in the form of an agriculturally acceptable derivative in the compositions according to the invention, for example as amides, such as mono- and di-C₁-C₆-alkylamides or arylamides, as esters, for example as allyl esters, propargyl esters, C₁-C₁₀-alkyl esters, alkoxyalkyl esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxy ethyl esters, for example the methoxyethyl, ethoxyethyl or butoxyethyl ester. An example of a straight-chain or branched C₁-C₁₀-alkylthio ester is the ethylthio ester.

Suitable and preferred salts and esters of specific herbicides A are listed above.

The compositions according to the present invention are useful in plant protection of soybeans. The term “plant” as used herein includes all parts of a plant such as germinating seeds, emerging seedlings and herbaceous vegetation including all below-ground portions (such as the roots) and aboveground portions.

Soybean or soya bean is a legume. In the context of the present invention, soybean refers to all species of the genus Glycine, including the wild (e.g. G. soya, G. Canescens, G. tomentella), as well as the cultivated (Glycine max) forms, with a preference for the cultivated form Glycine max.

The compositions according to the invention can also be used in genetically modified soybean plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

Soybean plants as well as the propagation material of said plants, which can be treated with the inventive mixtures include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, mixtures according to the present invention can be applied (as seed treatment, foliar spray treatment, in-furrow application or by any other means) also to plants which have been modified by breeding, mutagenesis or genetic engineering including but not limiting to agricultural biotech products on the market or in development (cf. http://www.bio.org/speeches/pubs/er/agri_products.asp).

Soybean plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones, e.g. imazamox; enolpyruvyl shikimate 3-phosphate synthase (EPSP) inhibitors such as glyphosate or sulfosate; glutamine synthetase (GS) inhibitors such as glufosinate or bialafos; protoporphyrinogen-IX oxidase (PPO) inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Genetic engineering methods have been used to render soybean tolerant to herbicides such as glyphosate, imidazolinones and glufosinate, some of which are under development or commercially available under the brands or trade names RoundupReady® (glyphosate tolerant, Monsanto, USA), STS® (sulfonylurea tolerant; DuPont, USA), Cultivance® (imidazolinone tolerant, BASF SE, Germany) and LibertyLink® (glufosinate tolerant, Bayer CropScience, Germany). Preferably, the soybean plants are tolerant against herbicides selected from the group of acetolactate synthase inhibitors (ALS inhibitors), e.g. chlorimuron-ethyl, thifensulfuron-methyl, tribenuron-methyl and their agriculturally acceptable salts; auxinic herbicides, e.g. 2,4-D, dicamba and their agriculturally acceptable salts, esters and amides; the 4-hydroxyphenylpyruvatedioxygenase (HDPP) inhibitors, e.g. bicyclopyrone, isoxaflutole, mesotrione, sulcotrione, tembotrione, topramezone and their agriculturally acceptable salts, EPSP synthase inhibitors, e.g. glyphosate, sulfosate and their agriculturally acceptable salts; and glutamine synthase inhibitors, e.g. glufosinate, bialafos and their agriculturally acceptable salts.

Furthermore, soybean plants are also covered that are by the use of recombinant DNA techniques capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, Cry-IIIB(b1) or Cry9c; vegetative insecticidal proteins (VIP), e. g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as Intacta® (caterpillar resistant, Monsanto, USA) and Genuity® (insect resistant, Monsanto, USA).

Furthermore, soybean plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes or T4-lyso-zym. The methods for producing such genetically modified plants are generally known to the person skilled in the art and are described, e.g., in the publications mentioned above.

Furthermore, soybean plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of ingredients or new ingredients, specifically to improve human or animal nutrition.

Furthermore, plants are also covered that contain by the use of recombinant DNA techniques a modified amount of ingredients or new ingredients, specifically to improve raw material production.

The compositions to be used according to the invention or the crop protection compositions comprising them or formulated therefrom can be used, for example, in the form of ready-to-spray aqueous solutions, powders, suspensions, also highly concentrated aqueous, oily or other suspensions or dispersions, emulsions, oil dispersions, pastes, dusts, materials for broadcasting, or granules, by means of spraying, atomizing, dusting, broadcasting or watering or treatment of the seed or mixing with the seed. The use forms depend on the intended purpose; in any case, they should ensure the finest possible distribution of the active compounds according to the invention.

The crop protection compositions comprise an effective amount of the composition according to the invention, i.e. at least one herbicide A or an agriculturally useful salt thereof and at least one fungicide B, and also auxiliaries customary for formulating crop protection agents.

Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineers Handbook, 4th Ed., McGraw-Hill, New York, 1963, S. 8-57 und ff. WO 91/13546, U.S. Pat. Nos. 4,172,714, 4,144,050, 3,920,442, 5,180,587, 5,232,701, 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The crop protection compositions may also comprise auxiliaries which are customary in agrochemical compositions. The auxiliaries used depend on the particular application form and active substance, respectively.

Examples of auxiliaries customary for the formulation of crop protection agents are inert auxilaries, solid or liquid carriers, surfactants (such as dispersants, protective colloids, emulsifiers, wetting agents and tackifiers), organic and inorganic thickeners, bactericides, antifreeze agents, antifoams, optionally colorants and, for seed formulations, adhesives.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R. T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on diclorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide® MBS from Thor Chemie).

Examples of antifreeze agents are ethylene glycol, propylene glycol, urea or glycerol. Examples of colorants are both sparingly water-soluble pigments and water-soluble dyes. Examples which may be mentioned are the dyes known under the names Rhodamin B, C. I. Pigment Red 112 and C. I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives (tackifiers or binders) are polyvinylpyrrolidone, polyvinyl acetate, polyvinyl alcohol and cellulose ethers (Tylose®, shin-Etsu, Japan). Suitable inert auxiliaries are, for example, the following:
mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydronaphthalene, alkylated naphthalenes and their derivatives, alkylated benzenes and their derivatives, alcohols such as methanol, ethanol, propanol, butanol and cyclohexanol, ketones such as cyclohexanone or strongly polar solvents, for example amines such as N-methylpyrrolidone, and water.

Suitable carriers include liquid and solid carriers.

Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof.

Solid carriers include e.g. mineral earths such as silicas, silica gels, silicates, talc, kaolin, limestone, lime, chalk, bole, loess, clay, dolomite, diatomaceous earth, calcium sulfate, magnesium sulfate and magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

Powders, materials for broadcasting and dusts can be prepared by mixing or grinding the active ingredients together with a solid carrier.

Granules, for example coated granules, impregnated granules and homogeneous granules, can be prepared by binding the active ingredients to solid carriers.

Aqueous use forms can be prepared from emulsion concentrates, suspensions, pastes, wettable powders or water-dispersible granules by adding water. To prepare emulsions, pastes or oil dispersions, the components of the compositions according to the invention either as such or dissolved in an oil or solvent, can be homogenized in water by means of a wetting agent, tackifier, dispersant or emulsifier. Alternatively, it is also possible to prepare concentrates comprising active compound, wetting agent, tackifier, dispersant or emulsifier and, if desired, solvent or oil, which are suitable for dilution with water.

In the formulation of the compositions according to the present invention the active ingredients are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

The compositions of the invention can for example be formulated as follows:
1. Products for dilution with water
   A Water-soluble concentrates (SL, LS)

10 parts by weight of active compound are dissolved in 90 parts by weight of water or a water-soluble solvent. As an alternative, wetters or other adjuvants are added. The active compound dissolves upon dilution with water. This gives a formulation with an active compound content of 10% by weight.
B Dispersible concentrates (DC)

20 parts by weight of active compound are dissolved in 70 parts by weight of cyclohexanone with addition of 10 parts by weight of a dispersant, for example polyvinylpyrrolidone. Dilution with water gives a dispersion. The active compound content is 20% by weight
C Emulsifiable concentrates (EC)

15 parts by weight of active compound are dissolved in 75 parts by weight of an organic solvent (e.g. alkylaromatics) with addition of calcium dodecylbenzenesulfonate and castor oil ethoxylate (in each case 5 parts by weight). Dilution with water gives an emulsion. The formulation has an active compound content of 15% by weight.
D Emulsions (EW, EO, ES)

25 parts by weight of active compound are dissolved in 35 parts by weight of an organic solvent (e.g. alkylaromatics) with addition of calcium dodecylbenzenesulfonate and castor oil ethoxylate (in each case 5 parts by weight). This mixture is introduced into 30 parts by weight of water by means of an emulsifier (e.g. Ultraturrax) and made into a homogeneous emulsion. Dilution with water gives an emulsion. The formulation has an active compound content of 25% by weight.
E Suspensions (SC, OD, FS)

In an agitated ball mill, 20 parts by weight of active compound are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.
F Water-dispersible granules and water-soluble granules (WG, SG)

50 parts by weight of active compound are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.
G Water-dispersible powders and water-soluble powders (WP, SP, SS, WS)

75 parts by weight of active compound are ground in a rotor-stator mill with addition of 25 parts by weight of dispersants, wetters and silica gel. Dilution with water gives a stable dispersion or solution of the active compound. The active compound content of the formulation is 75% by weight.
H Gel formulations (GF)

In a ball mill, 20 parts by weight of active compound, 10 parts by weight of dispersant, 1 part by weight of gelling agent and 70 parts by weight of water or of an organic solvent are mixed to give a fine suspension. Dilution with water gives a stable suspension with active compound content of 20% by weight.
2. Products to be applied undiluted
   I Dusts (DP, DS)

5 parts by weight of active compound are ground finely and mixed intimately with 95 parts by weight of finely divided kaolin. This gives a dusting powder with an active compound content of 5% by weight.
J Granules (GR, FG, GG, MG)

0.5 parts by weight of active compound are ground finely and associated with 99.5 parts by weight of carriers. Current methods here are extrusion, spray-drying or the fluidized bed. This gives granules to be applied undiluted with an active compound content of 0.5% by weight.
K ULV solutions (UL)

10 parts by weight of active compound are dissolved in 90 parts by weight of an organic solvent, for example xylene. This gives a product to be applied undiluted with an active compound content of 10% by weight.

The concentrations of the active compounds in the ready-to-use preparations can be varied within wide ranges. In general, the formulations comprise from 0.001 to 98% by weight, preferably 0.01 to 95% by weight of at least one active compound. The active compounds are employed in a purity of from 90% to 100%, preferably 95% to 100% (according to NMR spectrum).

In the ready-to-use preparations, i.e. in the compositions to be used according to the invention in the form of crop protection compositions, the components A and B can be present formulated jointly or separately in suspended, emulsified or dissolved form. The use forms depend entirely on the intended applications.

The components A and B can be formulated and applied jointly or separately, simultaneously or in succession, before, during or after the emergence of the plants. In case of separate application, the order of the application of the components A and B is of minor importance. The only thing that is important is that the at least one active components A and B are present simultaneously at the site of action, i.e. are at the same time in contact with or taken up by the plant to be controlled and/or safened.

A first embodiment of the invention relates to the use compositions in the form of a crop protection composition formulated as a 1-component composition comprising the at least one active component A, at least one further active component B and optionally at least one safener C, and also a solid or liquid carrier and/or and, one or more surfactants, and, if desired, one or more further auxiliaries customary for crop protection compositions.

A second embodiment of the invention relates to compositions in the form of a crop protection composition formulated as a 2-component composition comprising a first formulation (component) comprising the at least one active component A, a solid or liquid carrier and, if appropriate, one or more surfactants, and a second component comprising at least one further active component B, and optionally at least one safener C, and a solid or liquid carrier and, if appropriate, and/or one or more surfactants, where additionally both components may also comprise further auxiliaries customary for crop protection compositions.

The compositions to be used according to the invention are suitable as herbicides. They are suitable as such or as an appropriately formulated composition. The compositions according to the invention control vegetation on non-crop areas very efficiently, especially at high rates of application. They act against broad-leafed weeds and grass weeds in soybean crops without causing any significant damage to the crop plants. This effect is mainly observed at low rates of application.

Furthermore, it has been found that the compositions according to the invention are also suitable for the defoliation and/or desiccation of plant parts. In this regard compositions have been found for the desiccation and/or defoliation of soybean plants, processes for preparing these compositions, and methods for desiccating and/or defoliating soybean plants using the compositions according to the invention.

As desiccants, the compositions according to the invention are suitable in particular for desiccating the above-ground parts of soybeans. This makes possible the fully mechanical harvesting of these plants.

Also of economic interest is the facilitation of harvesting, which is made possible by concentrating within a certain period of time the dehiscence, or reduction of adhesion to the plant.

In the methods and uses according to the invention, it is principally of no importance whether the active compounds of components A and B are formulated and applied jointly or separately and in which order application is carried out in the case of separate application.

In crop protection products, it is desirable in principle to increase the specificity and the reliability of the action of active compounds. In particular, it is desirable for the crop protection product to control the harmful plants effectively and, at the same time, to be tolerated by the useful plants in question. It is known that in some cases better crop plant compatibility can be achieved by joint application of specifically acting herbicides with organic active compounds, which act as antidotes or antagonists. Owing to the fact that they can reduce or even prevent damage to the crop plants, they are also referred to as safeners.

It is therefore a further object of the present invention to provide herbicidal compositions, which are highly active against unwanted harmful plants, and, at the same time, the compositions should have good compatibility with useful plants. In addition, the compositions according to the invention should have a broad spectrum of activity.

This object is also achieved by the herbicidal active compositions comprising at least one herbicide A as defined herein and at least one fungicide B as defined herein.

The crop protection compositions comprise an herbicidally effective amount of the composition according to the invention, i.e. at least one herbicide A or an agriculturally useful salt thereof and at least one further active compound B, and also auxiliaries customary for formulating crop protection agents as defined herein.

The required application rate of pure active compound composition, i.e. A and B and, if appropriate, C without formulation auxiliaries depends on the composition of the plant stand, on the development stage of the plants, on the climatic conditions at the site of use and on the application technique. In general, the application rate of A and B is from 0.001 to 3 kg/ha, preferably from 0.005 to 2.5 kg/ha and in particular from 0.01 to 2 kg/ha of active substance (a.s.).

The required application rates of the herbicide A are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of the fungicide B are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of the optional safener C are generally in the range of from 0.0005 kg/ha to 2.5 kg/ha and preferably in the range of from 0.005 kg/ha to 2 kg/ha or 0.01 kg/ha to 1.5 kg/h of a.s.

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence or together with the seed of a crop plant. It is also possible to apply the compounds and compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition to be used according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula I according to the invention or the compositions prepared therefrom. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the soybean plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the compounds I are generally employed in amounts of from 0.001 to 10 kg per 100 kg of seed.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

The herbicidal effect of the compositions to be used according to the present invention comprising at least an herbicide A and a fungicide B, and optionally one or more safeners C, on the growth of undersirable plants and the safening action on crops was demonstrated by the following greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly, and grown in the same containers, or they were first grown separately as seedlings and transplanted into the test containers a few days prior to treatment.

Depending on the species, the plants were kept at 10-25° C. and 20-35° C., respectively. The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. Good herbicidal activity is given at values of at least 70, and very good herbicidal activity is given at values of at least 85.

The respective stated components A and B, and if appropriate, C were formulated as a 10% by weight strength emulsion concentrate and, with addition of the amount of solvent system, introduced into the spray liquor used for applying the active compound. In the examples, the solvent used was water.

The test period extended over 20 and 21 days, respectively. During this time, the plants were tended, and their reaction to the treatment with active compound was monitored.

In the examples below, using the method of S. R. Colby (1967) “Calculating synergistic and antagonistic responses of herbicide combinations”, Weeds 15, p. 22ff., the value E, which is expected if the activity of the individual active compounds is only additive, was calculated.

E=X+Y−(X·Y/100)

where
X=percent activity using active compound A at an application rate a;
Y=percent activity using active compound B at an application rate b;
E=expected activity (in %) by A+B at application rates a+b.

If the value found experimentally is higher than the value E calculated according to Colby, a synergistic effect is present.

In all uses and methods of the present invention the compositions preferably contain the at least one compound A and the at least one compound B in synergistically effective amounts, i.e. in a weight ratio of A and B such that a synergistic effect takes place. This means that the relative amount, i.e. the weight ratio of the at least one compound A and the at least one compound B in the composition provides for an increased herbicidal efficacy on at least one weed which exceeds the additive herbicidal efficacy of the compounds of the composition as calculated from the herbicidal efficacy of the individual compounds at a given application rate. The calculation of the additive efficacies can be performed e.g. by Colby's formula (Colby, S. R. “Calculating synergistic and antagonistic responses of herbicide Combinations”, Weeds, 15, 20-22, 1967). Synergism is present if the observed efficacy is greater than the calculated efficacy.

To ensure synergism, the at least one compound of the formula A and the at least one compound B are preferably present in the compositions of the present invention in a total weight ratio of from 100:1 to 1:100, more preferably from 50:1 to 1:50, even more preferably from 20:1 to 1:20, and in particular from 10:1 to 1:10, e.g. from 5:1 to 1:5 or from 3:1 to 1:3 or from 2:1 to 1:2.

1-16. (canceled)

17. A method for controlling undesired vegetation in soybean cultures, which method comprises allowing an effective amount of an agrochemical composition comprising
A) at least one herbicide A selected from
A.a) acetylCoA carboxylase inhibitors (ACC inhibitors) selected from clethodim, cycloxydim, fenoxaprop, fluazifop, fluazifop-P, haloxyfop, haloxyfop-P, quizalofop, quizalofop-P, sethoxydim and tepraloxydim;
A.b) acetolactate synthase inhibitors (ALS inhibitors) selected from chlorimuron, cloransulam, diclosulam, flumetsulam, thifensulfuron and tribenuron;
A.c) auxinic herbicides selected from 2,4-D and dicamba;
A.d) the glutamine synthase (GS) inhibitor glufosinate;
A.e) the photosynthetic electron transport inhibitor at the photosystem II receptor site bentazone; and
A.f) 4-hydroxyphenylpyruvate-dioxygenase (HPPD inhibitors) selected from bicyclopyrone, isoxaflutole, mesotrione, sulcotrione, tembotrione and topramezone;
and their agriculturally acceptable salts esters and amides;
and
B) at least one fungicide B selected from
B.a) inhibitors of complex III at Qₒ site selected from azoxystrobin, coumethoxystrobin, coumoxystrobin, dimoxystrobin, enestroburin, fenaminstrobin, fenoxystrobin/flufenoxystrobin, fluoxastrobin, kresoximmethyl, metominostrobin, orysastrobin, picoxystrobin, pyraclostrobin, pyrametostrobin, pyraoxystrobin, trifloxystrobin, 2-[2-(2,5-dimethylphenyl-oxymethyl)phenyl]-3-methoxy-acrylic acid methyl ester, 2-(2-(3-(2,6-di-chlorphenyl)-1-methyl-allylideneaminooxymethyl)-phenyl)-2-methoxy-imino-N-methyl-acetamide, pyribencarb, and triclopyricarb/chlorodincarb;
B.b) inhibitors of complex II selected from bixafen, boscalid, carboxin, fluxapyroxad, isopyrazam, penflufen, penthiopyrad, sedaxane, 3-difluoromethyl-1-methyl-1H-pyrazole-4-carboxylic acid (9-dichloromethylene-1,2,3,4-tetrahydro-1,4-methano-naphthalen-5-yl)-amide, and 3-difluoromethyl-1-methyl-1H-pyrazole-4-carboxylic acid (2-(2,4-dichloro-phenyl)-2-methoxy-1-methyl-ethyl)-amide; and
B.c) the respiration inhibitor fluazinam
to act on the soybean plants or parts thereof and/or the environment where the soybean cultures grow or are to grow.

18. The method as claimed in claim 17, where the soybean plant is an herbicide tolerant plant.

19. The method as claimed in claim 18, where the soybean plant is tolerant against herbicides selected from the group of acetolactate synthase inhibitors (ALS inhibitors), auxinic herbicides, 4-hydroxyphenylpyruvate-dioxygenase (HPPD) inhibitors, EPSP synthase inhibitors and glutamine synthase inhibitors.

20. The method as claimed in claim 19, where the acetolactate synthase inhibitor is selected from chlorimuron-ethyl, thifensulfuron-methyl, tribenuron-methyl and their agriculturally acceptable salts.

21. The method as claimed in claim 19, where the auxinic herbicide is selected from 2,4-D, dicamba and their agriculturally acceptable salts, esters and amides.

22. The method as claimed in claim 19, where the 4-hydroxyphenylpyruvate-dioxygenase inhibitor is selected from bicyclopyrone, isoxaflutole, mesotrione, sulcotrione, tembotrione, topramezone and their agriculturally acceptable salts.

23. The method as claimed in claim 19, where the EPSP synthase inhibitor is selected from glyphosate, sulfosate and their agriculturally acceptable salts.

24. The method as claimed in claim 19, where the glutamine synthase inhibitor is selected from glufosinate, bialafos and their agriculturally acceptable salts.

25. A method for the desiccation and/or defoliation of soybean plants, which method comprises treating soybean plants or parts thereof with an effective amount of an agrochemical composition comprising
A) at least one herbicide A selected from
A.a) acetylCoA carboxylase inhibitors (ACC inhibitors) selected from clethodim, cycloxydim, fenoxaprop, fluazifop, fluazifop-P, haloxyfop, haloxyfop-P, quizalofop, quizalofop-P, sethoxydim and tepraloxydim;
A.b) acetolactate synthase inhibitors (ALS inhibitors) selected from chlorimuron, cloransulam, diclosulam, flumetsulam, thifensulfuron and tribenuron;
A.c) auxinic herbicides selected from 2,4-D and dicamba;
A.d) the glutamine synthase (GS) inhibitor glufosinate;
A.e) the photosynthetic electron transport inhibitor at the photosystem II receptor site bentazone; and
A.f) 4-hydroxyphenylpyruvate-dioxygenase (HPPD inhibitors) selected from bicyclopyrone, isoxaflutole, mesotrione, sulcotrione, tembotrione and topramezone;
and their agriculturally acceptable salts esters and amides; and
B) at least one fungicide B selected from
B.a) inhibitors of complex III at Qₒ site selected from azoxystrobin, coumethoxystrobin, coumoxystrobin, dimoxystrobin, enestroburin, fenaminstrobin, fenoxystrobin/flufenoxystrobin, fluoxastrobin, kresoximmethyl, metominostrobin, orysastrobin, picoxystrobin, pyraclostrobin, pyrametostrobin, pyraoxystrobin, trifloxystrobin, 2-[2-(2,5-dimethylphenyl-oxymethyl)phenyl]-3-methoxy-acrylic acid methyl ester, 2-(2-(3-(2,6-di-chlorphenyl)-1-methyl-allylideneaminooxymethyl)-phenyl)-2-methoxy-imino-N-methyl-acetamide, pyribencarb, and triclopyricarb/chlorodincarb;
B.b) inhibitors of complex II selected from bixafen, boscalid, carboxin, fluxapyroxad, isopyrazam, penflufen, penthiopyrad, sedaxane, 3-difluoromethyl-1-methyl-1H-pyrazole-4-carboxylic acid (9-dichloromethylene-1,2,3,4-tetrahydro-1,4-methano-naphthalen-5-yl)-amide, and 3-difluoromethyl-1-methyl-1H-pyrazole-4-carboxylic acid (2-(2,4-dichloro-phenyl)-2-methoxy-1-methyl-ethyl)-amide; and
B.c) the respiration inhibitor fluazinam.

26. The method as claimed in claim 25, where the soybean plant is an herbicide tolerant plant.

27. The method as claimed in claim 26, where the soybean plant is tolerant against herbicides selected from the group of acetolactate synthase inhibitors (ALS inhibitors), auxinic herbicides, 4-hydroxyphenylpyruvate-dioxygenase (HPPD) inhibitors, EPSP synthase inhibitors and glutamine synthase inhibitors.

28. The method as claimed in claim 27, where the acetolactate synthase inhibitor is selected from chlorimuron-ethyl, thifensulfuron-methyl, tribenuron-methyl and their agriculturally acceptable salts.

29. The method as claimed in claim 27, where the auxinic herbicide is selected from 2,4-D, dicamba and their agriculturally acceptable salts, esters and amides.

30. The method as claimed in claim 27, where the 4-hydroxyphenylpyruvate-dioxygenase inhibitor is selected from bicyclopyrone, isoxaflutole, mesotrione, sulcotrione, tembotrione, topramezone and their agriculturally acceptable salts.

31. The method as claimed in claim 27, where the EPSP synthase inhibitor is selected from glyphosate, sulfosate and their agriculturally acceptable salts.

32. The method as claimed in claim 27, where the glutamine synthase inhibitor is selected from glufosinate, bialafos and their agriculturally acceptable salts.
